(19) United States
(12) Patent Application Publication
(10) Pub. No.: US 2020/0059608 A1
(43) Pub. Date: Feb. 20, 2020

(54) IMAGE PROCESSING DEVICE, CONTROL METHOD, AND PROGRAM

(71) Applicant: SONY CORPORATION, TOKYO (JP)

(72) Inventor: SHUTARO YOROZU, KANAGAWA (JP)

(21) Appl. No.: 16/342,667

(22) PCT Filed: Oct. 27, 2017
(86) PCT No.: PCT/JP2017/038848

§ 371 Date: Apr. 17, 2019

(30) Foreign Application Priority Data
Nov. 10, 2016 (JP) 2016-219407

(51) Int. Cl. H04N 5/262; H04N 5/60; H04N 5/232

(52) U.S. Cl. CPC H04N 5/2628; H04N 5/232933; H04N 5/23216; H04N 5/607

(57) ABSTRACT

The present technology relates to an image processing device, a control method, and a program which are capable of improving convenience. The image processing device includes: a setting unit that sets a flip function of displaying an image in a state of being vertically inverted to ON or OFF; and a control unit that performs control so that a display screen is allowed to be displayed on the basis of setting of the flip function, and in a case of receiving an operation instruction related to a predetermined direction from an external device, an operation related to the predetermined direction is performed with the display screen set as a reference. The present technology is applicable to a digital camera.

### TECHNICAL FIELD

The present technology relates to an image processing device, a control method, and a program, and more particularly, to an image processing device, a control method, and a program which are configured to improve convenience.

### BACKGROUND ART

For example, as a technology related to a camera, there is suggested a technology in which an image of one visual field is laterally inverted and displayed when displaying a half-wide image in which two images different in a visual field are cut out from an image acquired by developing a wide-view image and are arranged in parallel (for example, refer to Patent Document 1).

When capturing an image after installing the camera to which the technology is applied in a vehicle, and displaying an acquired half-wide image, landscapes flow in the same direction in two regions different in a visual field in the half-wide image, and thus the technology can be used for applications such as driving assistance.

In addition, when capturing an image with the camera, image capturing may be performed in a state in which the camera is carried by hands or image capturing may be performed in a state in which the camera is fixed to a vehicle, a ceiling, or the like in accordance with use applications. However, when a moving image is captured in a state in which the camera is inverted, the top and bottom of an image or right and left channels of sound are inverted.

Therefore, there is also suggested a function of vertically inverting a recording image or exchanging right and left channels of sound on the assumption that image capturing is performed in a state in which a camera is inverted.

### CITATION LIST

### Patent Document

Patent Document 1: Japanese Patent Application Laid-Open No. 2008-28778

### SUMMARY OF THE INVENTION

### Problems to be Solved by the Invention

However, in the above-described technology, when capturing an image in a state in which a camera is inverted, and the like, an image capturing operation and the like are inconvenient, and thus it cannot be said that convenience is sufficiently improved by only vertically inverting a captured image.

The present technology has been made in consideration of such circumstances, and an object thereof is to improve convenience.

### Solutions to Problems

According to an aspect of the present technology, there is provided an image processing device including: a setting unit that sets a flip function of displaying an image in a state of being vertically inverted to ON or OFF; and a control unit that performs control so that a display screen is allowed to be displayed on the basis of setting of the flip function, and in a case of receiving an operation instruction related to a predetermined direction from an external device, an operation related to the predetermined direction is performed with the display screen set as a reference.

In a case where the flip function is set to ON, the control unit may allow the display screen to be displayed in a state of being vertically inverted.

In a case where the flip function is set to ON, when receiving an operation instruction related to an upward direction with the external device set as a reference from the external device, the control unit may perform control so that an operation to the upward direction with the vertically and invertedly displayed display screen set as a reference is performed.

In a case where the flip function is set to OFF, the control unit may allow the display screen to be displayed without being vertically inverted, and may perform control so that, when receiving an operation instruction related to an upward direction with the external device set as a reference from the external device, an operation to the upward direction with the display screen displayed without vertical inversion set as a reference is performed.

The display screen may set as a menu screen in which a plurality of menu items are arranged in parallel.

In a case where the flip function is set to ON, the control unit may allow the menu screen to be displayed in a state of being vertically inverted, and when receiving an operation instruction related to the predetermined direction from the external device, the control unit may select the menu item on the menu screen with the vertically and invertedly displayed menu screen set as a reference on the basis of the operation instruction related to the predetermined direction.

In a case of receiving an operation instruction associated with no direction from the external device, the control unit may perform control so that the operation associated with no direction is performed without depending on setting of the flip function.

In a case where the flip function is set to ON, at least one of vertical inversion of an image acquired through image capturing, exchange of right and left channels of collected sound acquired through sound collection, vertical inversion display of the display screen, or change of allocation functions between operation units associated with directions different from each other may be performed.

According to another aspect of the present technology, there is provided a control method or a program which includes steps of: setting a flip function of displaying an image in a state of being vertically inverted to ON or OFF; and performing control so that a display screen is allowed to be displayed on the basis of setting of the flip function, and in a case of receiving an operation instruction related to a predetermined direction from an external device, an operation related to the predetermined direction is performed with the display screen set as a reference.

In the aspect of the present technology, a flip function of displaying an image in a state of being vertically inverted is set to ON or OFF, and control is performed so that a display screen is allowed to be displayed on the basis of setting of the flip function, and in a case of receiving an operation instruction related to a predetermined direction from an external device, an operation related to the predetermined direction is performed with the display screen set as a reference.

### Effects of the Invention

According to the aspects of the present technology, it is possible to improve convenience.

Furthermore, the effect described herein is not limited, and may be any one effect described in the present disclosure.

### BRIEF DESCRIPTION OF DRAWINGS

FIG. 1 is a view illustrating a configuration example of an external appearance of an imaging device.

FIG. 2 is a view illustrating a configuration example of the external appearance of the imaging device.

FIG. 3 is a view illustrating a configuration example of the external appearance of the imaging device.

FIG. 4 is a view illustrating a configuration example of the external appearance of the imaging device.

FIG. 5 is a diagram illustrating a functional configuration example of the imaging device.

FIG. 6 is a view illustrating flip setting.

FIG. 7 is a view illustrating the flip setting.

FIG. 8 is a view illustrating the flip setting.

FIG. 9 is a flowchart illustrating flip setting processing.

FIG. 10 is a view illustrating the flip setting and capturing of a moving image.

FIG. 11 is a view illustrating the flip setting and capturing of a moving image.

FIG. 12 is a flowchart illustrating image capturing processing.

FIG. 13 is a view illustrating the flip setting and image output.

FIG. 14 is a view illustrating the flip setting and image output.

FIG. 15 is a flowchart illustrating output processing.

FIG. 16 is a view illustrating the flip setting and behavior of a direction key.

FIG. 17 is a view illustrating the flip setting and behavior of a direction key.

FIG. 18 is a view illustrating display switching related to a DISP function.

FIG. 19 is a view illustrating display switching related to the DISP function.

FIG. 20 is a view illustrating display switching related to the DISP function.

FIG. 21 is a view illustrating a display example of a function setting screen.

FIG. 22 is a view illustrating a display example of a WB setting screen.

FIG. 23 is a view illustrating a display example of a menu screen.

FIG. 24 is a flowchart illustrating key operation processing.

FIG. 25 is a view illustrating a configuration example of an external appearance a remote operation device.

FIG. 26 is a flowchart illustrating command execution processing.

FIG. 27 is a diagram illustrating a configuration example of a computer.

FIG. 28 is a diagram illustrating an example of a schematic configuration of an endoscopic operating system.

FIG. 29 is a block diagram illustrating an example of a functional configuration of a camera head and a CCU which are illustrated in FIG. 28.

### MODE FOR CARRYING OUT THE INVENTION

Hereinafter, embodiments to which the present technology is applied will be described with reference to the accompanying drawings.

### First Embodiment

<Configuration Example of External Appearance of Imaging Device>

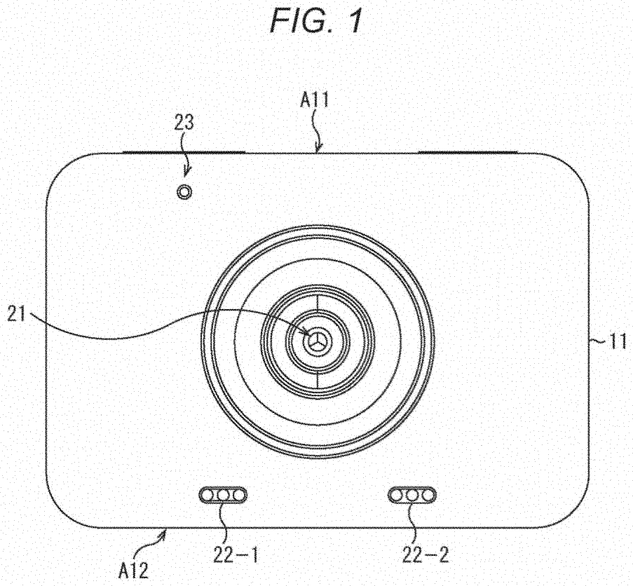

First, description will be given of a configuration example of an external appearance of an imaging device which is an example of an image processing device to which the present technology is applied with reference to FIG. 1 to FIG. 4.

FIG. 1 is a front view of the external appearance of the imaging device.

For example, an imaging device 11 is constituted by a digital camera and the like and has a configuration capable of capturing an image in a state in which a user who is a photographer carries the imaging device 11 with hands and capable of capturing an image in a state in which the imaging device 11 is fixed to a bicycle, a ceiling, a wall, or the like.

A lens 21 that guides light from a subject to an imaging element (not illustrated) is provided on a front surface of the imaging device 11. In addition, a sound collection unit 22-1 and a sound collection unit 22-2 which are constituted by a microphone that collects ambient sound at the time of capturing a moving image are provided on a lower side of the lens 21 on the front surface of the imaging device 11 in the drawing. Basically, sound collected by the sound collection unit 22-1 becomes sound of a right channel and sound collected by the sound collection unit 22-2 becomes sound of a left channel.

Furthermore, in the following description, the sound collection unit 22-1 and the sound collection unit 22-2 are also simply referred to as “sound collection unit 22” in a case where it is not necessary to particularly distinguish the units.

A tally lamp 23 is provided on an upper-left side of the front portion of the imaging device 11 in the drawing. The tally lamp 23 is turned on during capturing of a moving image by the imaging device 11 and is turned off while capturing of the moving image is not performed.

In addition, typically, when a moving image or a still image is captured with the imaging device 11, image capturing is performed in a state in which a top surface indicated by an arrow A11 faces a vertically upward side, that is, in a state in which a bottom surface indicated by an arrow A12 faces a ground surface.

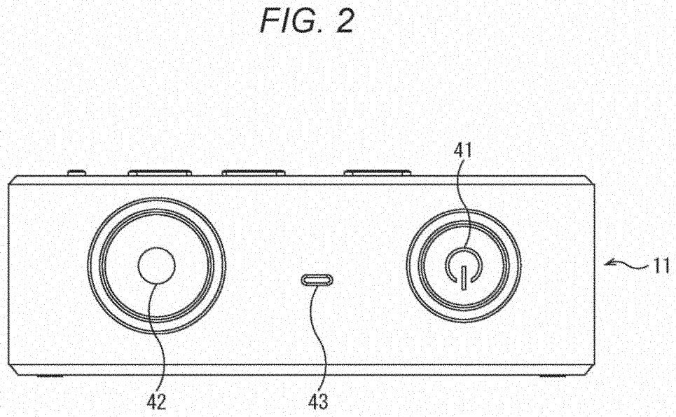

Accordingly, for example, as illustrated in FIG. 2, a power supply button 41, a shutter button 42, a sound output unit 43, and the like are provided on the top surface of the imaging device 11. Furthermore, FIG. 2 is a top view of the imaging device 11 when viewed from the upper side toward a downward direction in FIG. 1.

The power supply button 41 is a button that is operated when the imaging device 11 is powered on or off. The shutter button 42 is operated when capturing a still image, when initiating capturing of a moving image, when stopping capturing of a moving image, and the like. In addition, the shutter button 42 functions as an Enter key (a selection button) for determining selection in a state in which a menu screen or the like is displayed on a display unit (not illustrated).

For example, the sound output unit 43 is constituted by a speaker and the like and reproduces sound of a moving image at the time of reproduction of the moving image.

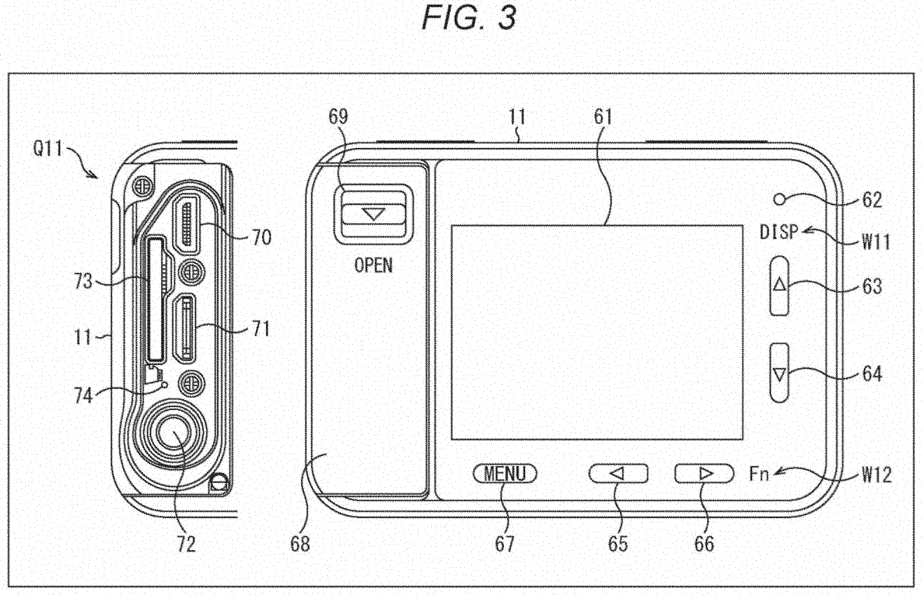

In addition, on a surface opposite to the front surface of the imaging device 11 illustrated in FIG. 1, that is, a rear surface of the imaging device 11, for example, various buttons and the like are provided as illustrated in FIG. 3. Furthermore, in FIG. 3, an upper side of the imaging device 11 in FIG. 3 is a top surface side, and a lower side of the imaging device 11 in FIG. 3 is a bottom surface side.

A display unit 61 which is constituted, for example, by a liquid crystal display (LCD) and the like and which displays various images is provided on the rear surface of the imaging device 11.

In addition, a tally lamp 62, an upward button 63, a downward button 64, a leftward button 65, a rightward button 66, and a menu button 67 are provided at the periphery of the display unit 61.

Similarly to the tally lamp 23 provided on the front surface of the imaging device 11, the tally lamp 62 is turned on when a moving image is being captured and is turned off when a moving image is not captured.

The upward button 63 is operated when an upward operation is performed on an image, a menu screen, or the like displayed on the display unit 61.

That is, the upward button 63 is operated, for example, when moving a cursor or the like on a menu screen toward a top end of the menu screen, when performing a scrolling operation for displaying a region close to the top end of an image acquired by image capturing, or the like.

In the following description, particularly, it is assumed that a direction from the center of an image, a menu screen, or the like toward the top end thereof is also referred to as “screen upward direction”, and similarly, directions from the center of the image, the menu screen, or the like toward the bottom, the left end, and the right end are also referred to as “screen downward direction”, “screen leftward direction”, and “screen rightward direction”, respectively. For example, the screen upward direction is an upward direction with an image, a menu screen, or the like set as a reference, that is, on the image, the menu screen, or the like.

In addition, in the following description, it is assumed that functions of performing operations associated with the screen upward direction, the screen downward direction, the screen leftward direction, and the screen rightward direction on an image, a menu screen, or the like are also referred to as “upward operation function”, “downward operation function”, “leftward operation function”, and “rightward operation function”, respectively.

Accordingly, the upward operation function such as an operation associated with the upward direction with a display screen such as an image and a menu screen set as a reference, that is, a scrolling operation of moving a cursor or the like in the screen upward direction or displaying a region close to an end in the screen upward direction, is allocated to the upward button 63.

In addition, the upward button 63 is also operated when display on the display unit 61 is switched at the time of capturing an image or reproducing an image. That is, when the upward button 63 is operated, the display on the display unit 61 is switched in correspondence with the operation on the upward button 63 in a state in which marks and the like which indicate various settings are displayed minimum necessary, a state in which a lot of marks and the like which indicate various settings are displayed, a state in which a histogram associated with an image is displayed, and the like.

In the following description, a function of switching the display on the display unit 61 at the time of capturing an image or reproducing an image is referred to as “DISP function”.

In this manner, the upward operation function and the DISP function are allocated to the upward button 63.

Characters “DISP” indicating the DISP function are printed above the upward button 63 in the drawing, that is, in a portion indicated by an arrow W11, on the rear surface of the imaging device 11. A user can instantaneously understand that the DISP function is allocated to the upward button 63 when viewing the printed characters.

The downward button 64 is disposed below the upward button 63 in the drawing, that is, on the bottom surface side thereof. The downward button 64 is operated when performing a screen downward operation. That is, a downward operation function is allocated to the downward button 64.

In addition, an arbitrary function among a plurality of predetermined functions in addition to the downward operation function can be selectively allocated to the downward button 64. For example, in initial setting, a reproduction function is allocated to the downward button 64. Reproduction of the latest captured image is initiated when the downward button 64 is operated.

The rightward button 66 is operated when performing a screen rightward operation on an image, a menu screen, and the like which are displayed on the display unit 61. That is, the rightward operation function is allocated to the rightward button 66.

Specifically, the rightward button 66 is operated, for example, when moving a cursor or the like in the screen rightward direction on a menu screen, when performing a scrolling operation of displaying a region close to a right end of an image acquired by image capturing, and the like.

In addition, in addition to the rightward operation function, a function display function (hereinafter, referred to as “Fn function”) of displaying a function setting screen is also allocated to the rightward button 66. That is, for example, when the rightward button 66 is operated at the time of capturing an image, or the like, a function setting screen is displayed on the display unit 61.

Characters “Fn” indicating the Fn function are printed on the right of the rightward button 66 in the drawing, that is, in a portion indicated by an arrow W12, on the rear surface of the imaging device 11. A user can instantaneously understand that the Fn function is allocated to the rightward button 66 when viewing the printed characters.

Furthermore, an example in which characters such as characters “DISP” and “Fn” indicating functions allocated in advance to the buttons are printed in the vicinity of the buttons is described, but symbols indicating functions and the like may be printed.

The leftward button 65 is disposed on the left of the rightward button 66 in the drawing. The leftward button 65 is operated when a screen leftward operation is performed. That is, a leftward operation function is allocated to the leftward button 65.

In addition, an arbitrary function among a plurality of predetermined functions in addition to the leftward operation function can be selectively allocated to the leftward button 65. For example, in initial setting, a white balance (WB) setting function is allocated to the leftward button 65, and when the leftward button 65 is operated at the time of capturing an image or the like, a WB setting screen for selecting an image capturing environment serving as a premise for white balance adjustment is displayed on the display unit 61.

In this manner, the upward button 63, the downward button 64, the leftward button 65, and the rightward button 66 are associated with upward, downward, leftward, and rightward directions, and functions of performing an operation in the directions associated with the buttons (keys) and functions associated with no direction are allocated to thereto. That is, a function that is associated with a direction and a function that is not associated with a direction are allocated in advance to the buttons which are operation units associated with a direction.

In the following description, the upward button 63, the downward button 64, the leftward button 65, and the rightward button 66 are also referred to as “direction key” in a case where it is not necessary to particularly distinguish the buttons. In the example illustrated in FIG. 3, an arrow indicating a direction associated with each direction key is printed on the direction key. In addition, at least one function may be allocated to each direction key. That is, one or more functions may be allocated to each direction key.

A menu button 67 is disposed on the left of the leftward button 65 in the drawing. The menu button 67 is operated when displaying a menu screen on the display unit 61. That is, a menu display function of displaying a menu screen is allocated to the menu button 67.

A cover 68 is attached to the left of the display unit 61 in the drawing on the rear surface of the imaging device 11. The cover 68 is detachable from the imaging device 11 by operating a lock button 69.

As indicated by an arrow Q11, various terminals or slots are provided on a lower side of the cover 68 in the main body of the imaging device 11. Here, a view indicated by the arrow Q11 illustrates a state in which the cover 68 is detached from the left part of the rear surface of the main body of the imaging device 11.

In this example, a high-definition multimedia interface (HDMI) (registered trademark) terminal 70 and a universal serial bus (USB) (registered trademark) terminal 71 are provided as input/output terminals for external connection below the cover 68 of the main body of the imaging device 11.

In addition, a terminal 72 for attachment of a microphone, a slot 73 that is an insertion port of a removable recording medium detachable from the imaging device 11, and a medium access lamp 74 for giving a notification of access to the removable recording medium and the like are provided below the cover 68 of the main body of the imaging device 11.

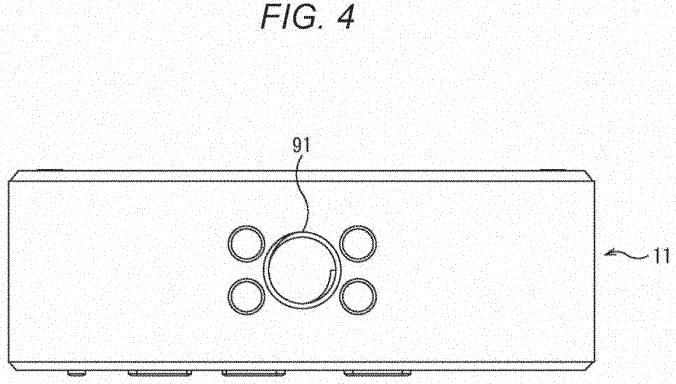

In addition, for example, as illustrated in FIG. 4, a socket 91 that is a fixing portion for fixing the imaging device 11 to a tripod or the like is provided on the bottom surface of the imaging device 11. When the imaging device 11 is fixed to a ceiling, a wall, or the like by using the socket 91, image capturing or the like can be performed in a state in which the imaging device 11 is inverted or rotated by 90 degrees.

<Functional Configuration Example of Imaging Device>

A functional configuration example of the imaging device 11 will be described below.

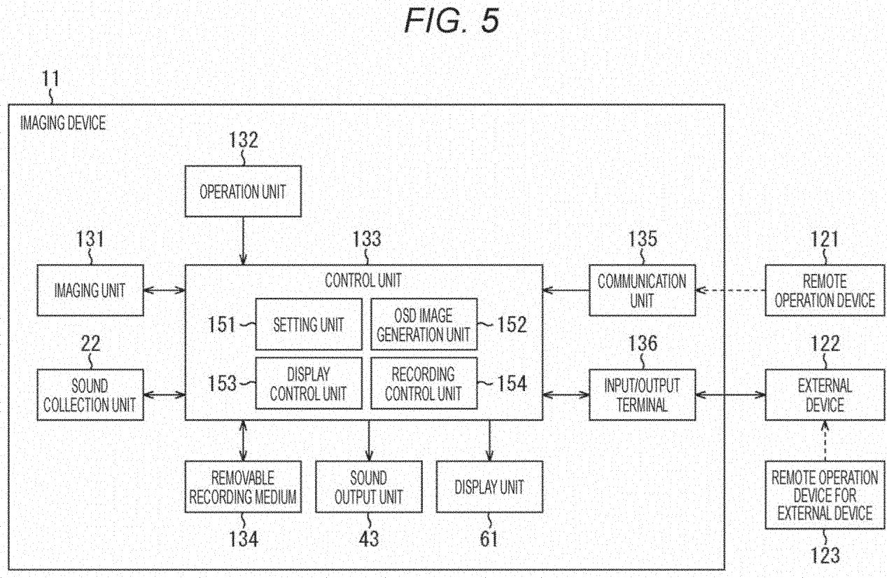

FIG. 5 is a diagram illustrating a functional configuration example of the imaging device 11. Furthermore, in FIG. 5, the same reference numeral will be given to a portion corresponding to a case in FIG. 1 to FIG. 4, and description thereof will be appropriately omitted.

In the example illustrated in FIG. 5, the imaging device 11 can be remotely operated with a remote operation device 121, and an external device 122 such as a display-equipped recorder or a display is connected to the imaging device 11. In the following description, it is assumed that the external device 122 is the display-equipped recorder. In addition, the external device 122 and the imaging device 11 can be remotely operated by a remote operation device 123 for an external device dedicated for the external device 122.

The imaging device 11 includes an imaging unit 131, a sound collection unit 22, an operation unit 132, a control unit 133, a removable recording medium 134, a sound output unit 43, a display unit 61, a communication unit 135, and an input/output terminal 136.

The imaging unit 131 includes the lens 21 illustrated in FIG. 1, an imaging element, and the like. The imaging unit 131 captures an image by receiving light from a subject and photoelectrically converting the received light under the control of the control unit 133, and supplies image data of an acquired image to the control unit 133. Furthermore, in the following description, an image acquired by the imaging unit 131 is also particularly referred to as “captured image”.

The sound collection unit 22 collects ambient sound under the control of the control unit 133 and supplies sound data of the collected sound acquired as a result to the control unit 133.

For example, the operation unit 132 includes the power supply button 41 and the shutter button 42 which are illustrated in FIG. 2, the upward button 63 to the menu button 67 which are illustrated in FIG. 3, a touch panel disposed to overlap the display unit 61, and the like, and supplies a signal corresponding to a user's operation to the control unit 133.

The control unit 133 controls the whole operations of the imaging device 11. The control unit 133 includes a setting unit 151, an on-screen-display (OSD) image generation unit 152, a display control unit 153, and a recording control unit 154.

The setting unit 151 performs various settings on the basis of a signal transmitted from the operation unit 132. The OSD image generation unit 152 generates an OSD image.

Examples of an OSD image include images indicating marks or images indicating various settings or states of the imaging device 11 such as a mark indicating an image capturing mode, an image indicating an amount of residual power of a battery, a mark indicating white balance setting, and the like.

The display control unit 153 controls display of various images on the display unit 61 or the external device 122. The recording control unit 154 controls recording of image data acquired through image capturing or sound data acquired through sound collection on the removable recording medium 134 or the external device 122.

The removable recording medium 134 is a recording medium that can be attached to and detached from the imaging device 11, and enters a state attached to the imaging device 11 when being inserted into the slot 73 illustrated in FIG. 3. The removable recording medium 134 records image data or sound data supplied from the control unit 133 and supplies image data or sound data recorded thereon to the control unit 133 as necessary.

The communication unit 135 receives a command transmitted from the remote operation device 121 through wireless or wired communication and supplies the received command to the control unit 133.

For example, the remote operation device 121 is a remote commander that is dedicated for the imaging device 11 or a general-purpose remote commander that transmits a command by wireless communication using infrared rays or the like or wired communication using the terminal 71 or the like, and may be realized by a smartphone or the like.

For example, the input/output terminal 136 is an input/output unit that is constituted by the terminal 70 and the terminal 71 illustrated in FIG. 3, or the like, and performs communication with the external device 122.

For example, the input/output terminal 136 outputs image data or sound data which is supplied from the control unit 133 to the external device 122, or outputs a command and the like which are supplied from the external device 122 to the control unit 133.

<With Regard to Flip Setting>

Incidentally, as described above, the imaging device 11 may be used in a state of being carried by hands of a user or may be used in a state of being fixed to a ceiling, a wall, or the like.

For example, when the imaging device 11 is used in a state of being fixed inversely, a captured image is recorded in a vertically inverted state and right and left channels of collected sound are recorded in an exchanged state.

Therefore, the imaging device 11 is provided with a flip function for prohibiting vertical inversion of an image even when the imaging device 11 is used in an inverted state. The flip function is a function of vertically inverting a display direction of an image such as a captured image, a reproduced image, and a menu screen to a predetermined direction, that is, the vertical direction herein. In addition, in this embodiment, even when the imaging device 11 is used in an inverted state, the right and left channels of sound are not inverted due to the flip function.

Here, with regard to a captured image acquired by the imaging unit 131, an angle-of-view confirmation image displayed on the display unit 61 during image capturing is referred to as “through-image”, and a recording image that is to be recorded on the removable recording medium 134 or the like is referred to as “recording image”. In addition, sound acquired by the sound collection unit 22 is also referred to as “collected sound”, and recording sound that is to be recorded on the removable recording medium 134 or the like is also referred to as “recording sound”.

For example, in a state in which flip setting is turned off, that is, in a state in which the flip function is set to OFF, it is assumed that the imaging device 11 is used in a non-inverted state, that is, in a state in which the bottom surface of the imaging device 11 faces a vertically downward side (the ground surface side).

Accordingly, in the state in which flip setting is turned off, a captured image and collected sound become a recording image and recording sound as is.

In addition, although details will be described later, a display screen such as an OSD image and a menu screen is also displayed so that the top surface of the imaging device 11 faces the screen upward direction in the state in which flip setting is turned off.

Furthermore, in the following description, images (screens) which are displayed on the display unit 61 such as a recording image, an OSD image, and a menu screen are also simply referred to as “display screen” in a case where it is not necessary to particularly distinguish the images (screens). Here, it is assumed that a through-image is not included in (is excluded from) the display screen.

In addition, in the following description, a display state in which a top end of a display screen, that is, an end in the screen upward direction is located on the top surface side of the display unit 61 when the display screen is displayed on the display unit 61 is referred to as “normal display state”. In the normal display state, on the display unit 61, characters and the like are displayed erectly to a user who uses the imaging device 11 in a state in which the top surface thereof is located on the upper side when seen from the user.

In contrast, in a state in which flip setting is turned on, that is, the flip function is set to ON, a captured image is vertically inverted, that is, the captured image is rotated by 180 degrees and is set as a recording image, and the right and left channels of collected sound are exchanged and are set as recording sound.

In addition, although details will be described later, a display screen such as an OSD image and a menu screen is vertically inverted and displayed such that the bottom surface of the imaging device 11 faces the screen upward direction in a state in which flip setting is turned on. That is, the display direction of the display screen is vertically inverted.

Furthermore, in the following description, a display state in which a top end of a display screen, that is, an end in the screen upward direction, is located on the bottom surface side of the display unit 61 when the display screen is displayed on the display unit 61 is referred to as “inverted display state”.

In the inverted display state, on the display unit 61, characters and the like are displayed erectly to a user who uses the imaging device 11 in a state in which the bottom surface thereof is located on the upper side when seen from the user. In other words, in the inverted display state, on the display unit 61, characters and the like are displayed in the vertically inverted state to a user who uses the imaging device 11 in a state in which the top surface thereof is located on the upper side when seen from the user.

Furthermore, in the state in which flip setting is turned on, behavior of the direction keys of the imaging device 11 also varies. That is, functions allocated to two direction keys associated with different directions are exchanged between the two direction keys.

In a case where the flip function is set to ON in this manner, vertical inversion of a captured image at the time of generating a recording image, exchange of the right and left channels of collected sound at the time of generating recording sound, vertically inverted display of a display screen, and exchange of allocated functions between the direction keys are performed, but at least one thereof may be performed. For example, when the flip function is set to ON, at least vertical inversion of a display direction of an image such as vertical inversion of a captured image at the time of generating a recording image or vertically inverted display of a display screen may be performed. In this case, exchange of the right and left channels of collected sound at the time of generating recording sound or exchange of allocated functions between the direction keys may be performed or may not be performed.

<With Regard to Operation in Flip Setting>

Flip setting will be described below in more details.

First, an operation when the flip function is set to ON or OFF will be described.

A user can perform a setting operation of setting flip setting to ON or OFF by operating the menu button 67 disposed on the rear surface of the imaging device 11 or the like to display a menu screen on the display unit 61.

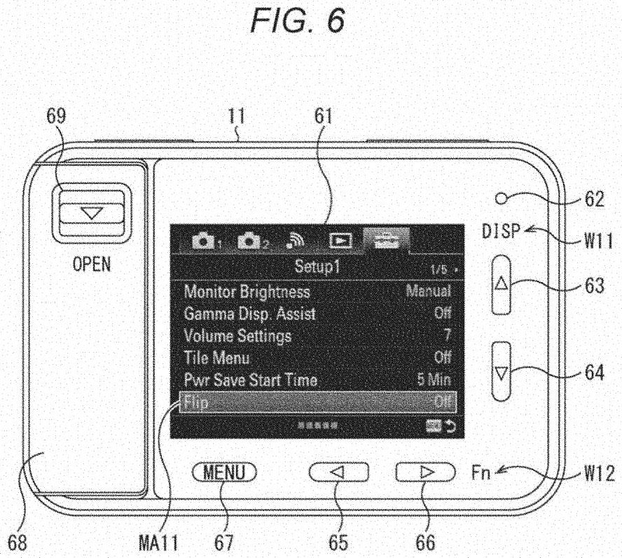

For example, when the menu button 67 is operated in a state in which flip setting is turned off, the display control unit 153 supplies data of a menu screen to the display unit 61 in correspondence with a signal supplied from the menu button 67 serving as the operation unit 132 and displays the menu screen illustrated in FIG. 6.

In the example illustrated in FIG. 6, a plurality of menu items including a menu item MA11 in which characters “Flip” are displayed are arranged (displayed) in parallel on the menu screen. The menu item MA11 is a menu item for performing flip setting, and characters “Off” displayed in the menu item MA11 indicate that current flip setting is turned off. Accordingly, in the example illustrated in FIG. 6, the display state of the menu screen is the normal display state.

In addition, in this example, the menu item MA11 is highlighted, that is, is in a display state different from that of other menu items, and the menu item MA11 is in a selected state.

In this state, for example, it is assumed that the user operates the shutter button 42 or the like disposed on the top surface of the imaging device 11 and gives an instruction for determination of selection of the menu item MA11.

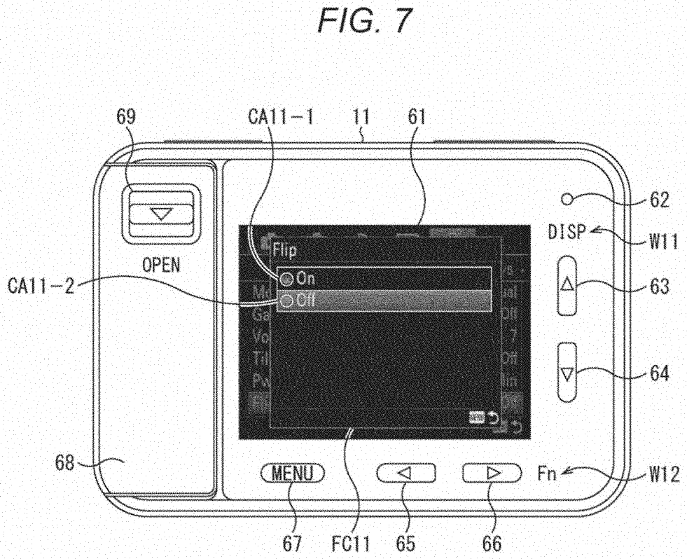

Then, the display control unit 153 supplies data of a flip setting screen to the display unit 61 in correspondence with a signal supplied from the shutter button 42 or the like serving as the operation unit 132 and displays, for example, the flip setting screen illustrated in FIG. 7.

In the example illustrated in FIG. 7, since a flip setting screen FC11 for performing flip setting is displayed to overlap the menu screen illustrated in FIG. 6 and flip setting is turned off, the flip setting screen FC11 is also displayed in the normal display state.

A setting item CA11-1 for setting the flip function to ON and a setting item CA11-2 for setting the flip function to OFF are displayed on the flip setting screen FC11. Particularly, characters “On” are displayed in the setting item CA11-1, and characters “Off” are displayed in the setting item CA11-2. Furthermore, in the following description, the setting item CA11-1 and the setting item CA11-2 are also simply referred to as “setting item CA11” when it is not necessary to particularly distinguish the items.

When the flip setting screen FC11 is displayed, the user performs flip setting by operating the direction keys, the shutter button 42, and the like to set the setting item CA11 as a selected state or to determine selection of the setting item CA11 that is in the selected state.

In the example illustrated in FIG. 7, the setting item CA11-2 for turning off flip setting is highlighted and is set to a selected state. When an operation of determining selection of the setting item CA11-2 is performed in this state, the setting unit 151 turns off the flip setting on the basis of a signal supplied from the operation unit 132 and records flip setting information indicating the setting result.

Furthermore, more specifically, the setting unit 151 records flip setting information and updates the flip setting information by setting the recorded flip setting information to information indicating that the flip function is set to OFF when selection of the setting item CA11-2 is determined.

When flip setting is turned off in this manner, the display control unit 153 returns, for example, the display of the display unit 61 to the menu screen illustrated in FIG. 6 or returns the display to a state before the menu screen is displayed, for example, a state in which a through-image is displayed.

On the other hand, when the setting item CA11-1 for turning on flip setting is selected and an operation of determining the selection of the setting item CA11-1 is performed by the user, the setting unit 151 turns on flip setting on the basis of a signal supplied from the operation unit 132 and records flip setting information indicating the setting result. That is, the flip setting information is updated with information indicating that the flip function is set to ON.

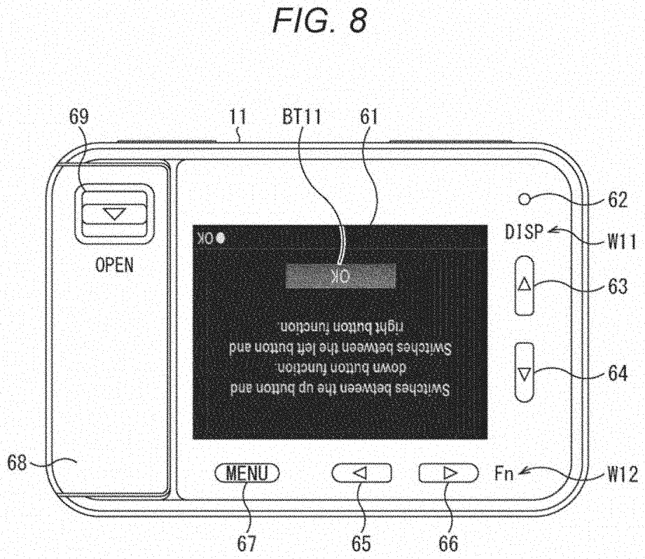

In addition, when flip setting is turned on, the display control unit 153 controls the display unit 61 immediately thereafter to display, for example, an explanation screen that is a screen associated with flip setting illustrated in FIG. 8, that is, a screen associated with setting of the flip function is displayed.

In this example, since flip setting is turned on, the explanation screen is displayed in the inverted display state. That is, the explanation screen is displayed in the vertically inverted state on the display unit 61 such that the top end of the explanation screen faces the bottom surface of the imaging device 11.

Explanation related to the flip function is displayed on the explanation screen. Specifically, characters “switches between the up button and down button function.” and characters “switches between the left button and right button function.” which indicate explanation related to behavior of the operation unit 132 when flip setting is turned on, particularly, behavior of the direction keys serving as the operation unit 132 are displayed on the explanation screen.

That is, explanation indicating exchange of behavior (functions) of buttons associated with opposite directions such as the upward button 63 and the downward button 64 among the direction keys is displayed on the explanation screen. Similarly, explanation indicating exchange of behavior (functions) of buttons associated with opposite directions such as the leftward button 65 and the rightward button 66 among the direction keys is also displayed on the explanation screen.

Furthermore, details of behavior of the direction keys or the like according to flip setting will be described later. In addition, description has been given of a case where explanation of behavior of the direction keys is displayed as an example of the explanation screen. However, the explanation screen is not particularly limited as long as explanation indicating behavior of the imaging device 11 or the like including a display state when flip setting is turned on such as explanation indicating that the display is vertically inverted and explanation of behavior of a remote operation device is displayed.

As described above, in the imaging device 11, immediately after flip setting is turned on, an explanation screen on which explanation of behavior of the imaging device 11 is displayed when flip setting is turned on is displayed in the inverted display state. With this arrangement, a user can be notified of a situation in which flip setting is turned on and can be allowed to intuitively and easily understand behavior after the setting. As a result, it is possible to improve convenience of the imaging device 11. Particularly, when the explanation screen is displayed in the inverted display state, a user can easily understand that the display of the display unit 61 is vertically inverted.

In addition, a button BT11 that is operated when a user has confirmed the explanation content of the explanation screen is also displayed on the explanation screen illustrated in FIG. 8, and characters “OK” are displayed in the button BT11.

When the button BT11 is provided on the explanation screen, a user can be prompted to confirm that flip setting is turned on. Accordingly, in this example, the explanation screen also serves as a confirmation screen for performing confirmation of flip setting, that is, confirmation of setting of the flip function with respect to a user.

When the button BT11 is operated by a user, the display of the display unit 61 is then returned to, for example, the menu screen illustrated in FIG. 6 or is returned to a state before the menu screen is displayed, for example, a state in which a through-image is displayed.

In addition, description has been given of an example in which the button BT11 which is an OK button for confirming that flip setting is turned on is provided on the explanation screen, but a cancellation button for canceling the operation of turning on flip setting in addition to the button BT11 may also be provided.

In this case, a user operates the cancellation button on the explanation screen by operating the direction keys or the like serving as the operation unit 132, thereby invalidating the selecting operation of turning on flip setting which has been performed by the user.

When the cancellation button is operated by a user in a state in which the explanation screen (the confirmation screen) is displayed to give an instruction for cancellation of the setting of turning on the flip function, the setting unit 151 cancels the setting of the flip function which has been performed immediately before the explanation screen is displayed on the basis of a signal transmitted from the operation unit 132. In addition, the display control unit 153 controls the display unit 61 to return the display of the display unit 61 to the flip setting screen FC11 illustrated in FIG. 7. Then, when flip setting is newly performed, the setting unit 151 records flip setting information indicating a new setting result.

When setting of turning on the flip function which has been performed immediately before can be canceled on the explanation screen of flip setting in this manner, it is possible to further improve convenience.

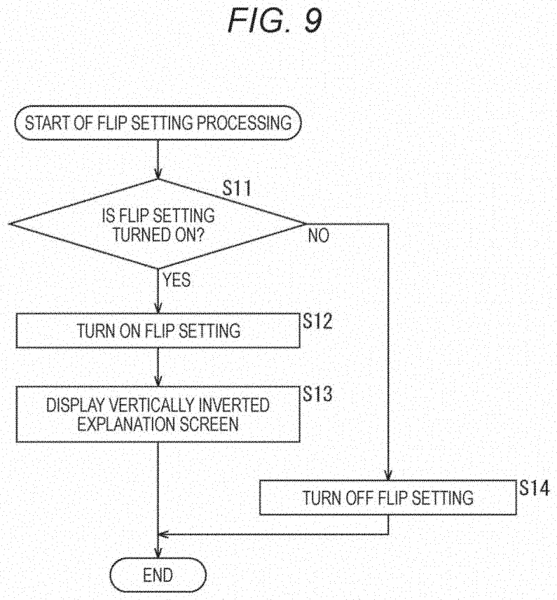

Description will be given of a specific operation of the imaging device 11 when the above-described flip setting is performed. That is, flip setting processing that is performed by the imaging device 11 will be described below with reference to the flowchart of FIG. 9. This flip setting processing is initiated when the flip setting screen FC11 illustrated in FIG. 7 is displayed on the display unit 61.

In step S11, the setting unit 151 determines whether or not to turn on flip setting on the basis of a signal transmitted from the operation unit 132.

For example, in a case where the operation unit 132 is operated by a user and selection of the setting item CA11-1 on the flip setting screen FC11 is determined, it is determined that flip setting is turned on. In contrast, in a case where selection of the setting item CA11-2 on the flip setting screen FC11 is determined, it is determined that flip setting is not to be turned on, that is, to be turned off.

In step S11, in a case where it is determined that flip setting is to be turned on, that is, in a case where an instruction for turning-on of the flip function is received, in step S12, the setting unit 151 turns on flip setting on the basis of a signal supplied fromthe operation unit 132 in correspondence with an operation of determining selection of the setting item CA11-1 by a user.

Specifically, the flip setting information recorded by the setting unit 151 is updated with information indicating that flip setting is turned on. In other words, the setting unit 151 generates flip setting information indicating that flip setting is turned on, and records the generated flip setting information.

In step S13, the display control unit 153 supplies data of the explanation screen to the display unit 61, controls the display unit 61 on the basis of the flip setting information that is recorded in the setting unit 151 and indicates that flip setting is turned on to allow the display unit 61 to display a vertically inverted explanation screen. With this arrangement, for example, as illustrated in FIG. 8, the explanation screen is displayed in the inverted display state on the display unit 61.

When the explanation screen is displayed, the flip setting processing is terminated. In this case, when the button BT11 is operated by a user, the display of the display unit 61 is returned to the menu screen or is returned to display of a through-image.

In contrast, in step S11, in a case where it is determined that flip setting is not to be turned on, that is, to be turned off, in step S14, the setting unit 151 turns off flip setting on the basis of a signal supplied from the operation unit 132 in correspondence with an operation of determining selection of the setting item CA11-2 by a user.

Specifically, the setting unit 151 updates the flip setting information that is recorded with information indicating that flip setting is turned off. In other words, the setting unit 151 generates flip setting information indicating that flip setting is turned off, and records the generated flip setting information.

When flip setting is turned off, the flip setting processing is terminated. In this case, the display of the display unit 61 is returned to, for example, the menu screen or is returned to display of a through-image. That is, when flip setting is turned off, the display control unit 153 does not display a screen related to setting of the flip function such as the explanation screen illustrated in FIG. 8, and the like.

When the flip setting information is recorded and flip setting is turned on in correspondence with a user's operation of the flip setting screen in this manner, the imaging device 11 displays the explanation screen in the inverted display state immediately thereafter. Accordingly, the user can be allowed to easily understand whether flip setting is turned on or what behavior is performed when flip setting is turned on. As a result, it is possible to improve convenience of the imaging device 11.

<With Regard to Capturing of Moving Image>

Operations at the time of capturing an image when flip setting is turned on or off will be described below.

For example, when a moving image is captured in a state in which flip setting is turned off, a captured image and collected sound become a recording image and recording sound as is. In addition, display in the normal display state is performed on the display unit 61.

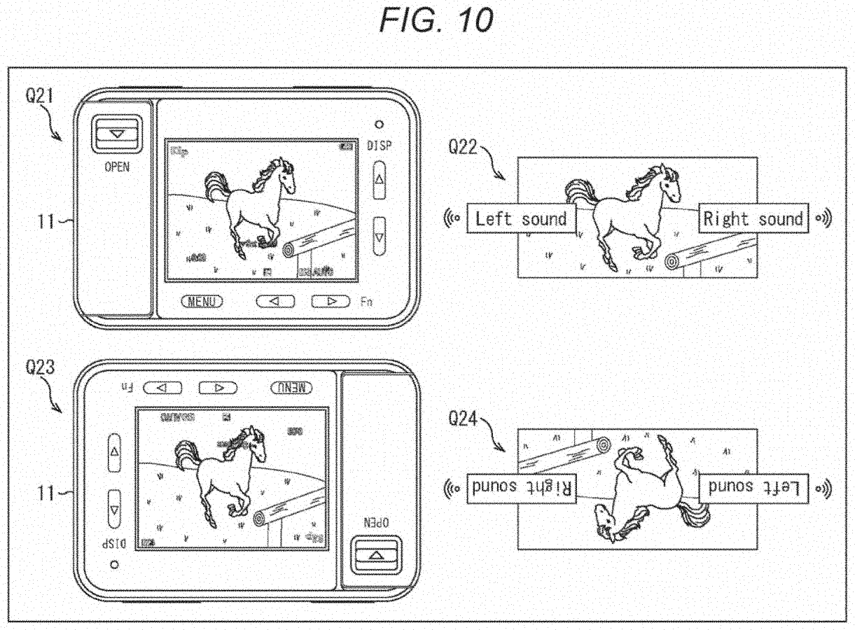

Accordingly, for example, when image capturing is performed in a state in which the bottom surface of the imaging device 11 faces the ground surface as indicated by an arrow Q21 in FIG. 10 (hereinafter, also referred to as “normal use state”), an OSD image or a through-image displayed on the display unit 61 is displayed erectly to a user.

Furthermore, when a user uses the imaging device 11 in the normal use state, it is assumed that the user sees the display unit 61 in a state in which the top surface thereof is located on the upper side of the imaging device 11 when seen from the user, and the bottom surface thereof is located on the lower side of the imaging device 11 when seen from the user. This is similar to the following description.

In addition, when a user uses the imaging device 11 in a state in which the imaging device 11 is vertically inverted (hereinafter, also referred to as “inverted use state”), it is assumed that the user sees the display unit 61 in a state in which the bottom surface thereof is located on the upper side of the imaging device 11 when seen from the user, and the top surface thereof is located on the lower side of the imaging device 11 when seen from the user.

In addition, a situation in which an OSD image or a through-image is displayed erectly to a user represents a situation in which characters on the OSD image are neither inverted nor laid down, and are displayed erectly to the user in the same way as a state in which a user generally sees the characters and a subject on the through-image is also displayed to the user in the same way as the user actually sees the subject. In the following description, when it is mentioned that something is seen erectly by a user, it means that an image or the like is seen from the user in this state.

When flip setting is turned off and image capturing is performed in the normal use state as indicated by the arrow Q21, a recording image is also recorded in a state similar to a state in which the user actually sees a subject as indicated by an arrow Q22 and recording sound is also recorded in a state in which the right and left channels are right.

In addition, for example, when flip setting is turned off and image capturing is performed in the inverted use state as indicated by an arrow Q23, that is, in a state in which the imaging device 11 is vertically inverted, a subject is displayed on the through-image as if the user sees an actual subject, but the OSD image is displayed in the vertically inverted state to the user.

Furthermore, when flip setting is turned off and image capturing is performed in the inverted use state as indicated by the arrow Q23, the recording image is recorded in the vertically inverted state unlike a subject that is actually seen by the user as indicated by an arrow Q24 and the recording sound is also recorded in a state in which the right and left channels are inverted unlike actual sound.

In this manner, when flip setting is turned off, the normal use state is a right use state and the inverted use state is a wrong use state. That is, when flip setting is turned off, use of the imaging device 11 in the normal use state is assumed, and use in the inverted use state is not assumed.

On the other hand, when a moving image is captured in a state in which flip setting is turned on, an image obtained by vertically inverting a captured image is set as a recording image, and sound obtained by exchanging the right and left channels of collected sound is set as recording sound. In addition, display in the inverted display state is performed on the display unit 61. However, a through-image is not displayed in the inverted display state, and is displayed in the normal display state.

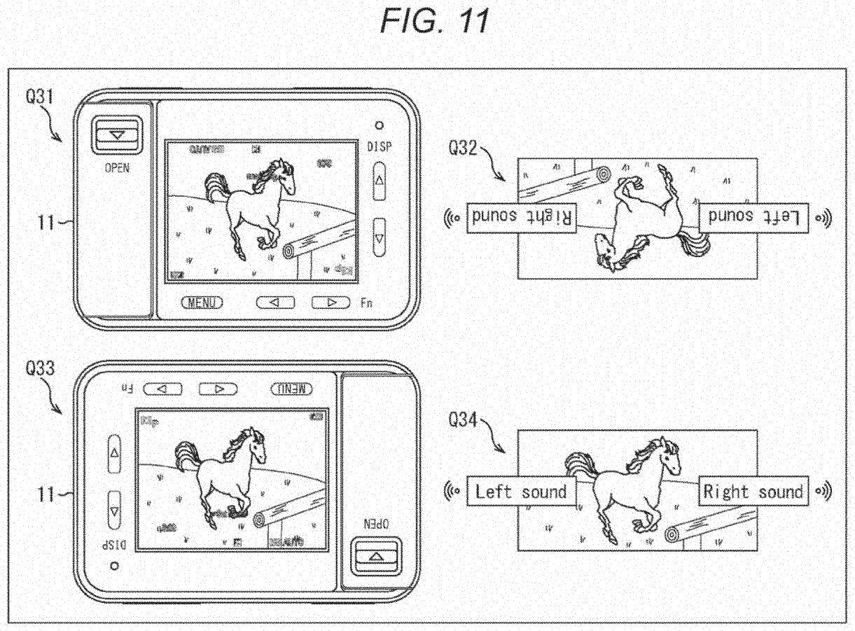

Accordingly, when flip setting is turned on and image capturing is performed by the imaging device 11 in the normal use state, for example, as indicated by an arrow Q31 in FIG. 11, a subject is displayed on a through-image in the same way as a user sees the actual subject, but an OSD image is displayed in the vertically inverted state to the user.

When flip setting is turned on and image capturing is performed in the normal use state as indicated by the arrow Q31, the recording image is recorded in the vertically inverted state unlike a subject which is actually seen by the user as indicated by an arrow Q32, and the recording sound is also recorded in a state in which the right and left channels are inverted unlike actual sound.

Furthermore, for example, when flip setting is turned on and image capturing is performed by the imaging device 11 in the inverted use state as indicated by an arrow Q33, an OSD image or a through-image displayed on the display unit 61 is seen erectly by a user.

When flip setting is turned on and image capturing is performed in the inverted use state as indicated by the arrow Q33, the recording image is recorded in the similar state to the user actually sees a subject as indicated by an arrow Q34 and the recording sound is also recorded in a state in which the right and left channels thereof are right.

In this manner, when flip setting is turned on, the inverted use state is a right use state and the normal use state is a wrong use state. That is, when flip setting is turned on, use of the imaging device 11 in the inverted use state is assumed, and use thereof in the normal use state is not assumed.

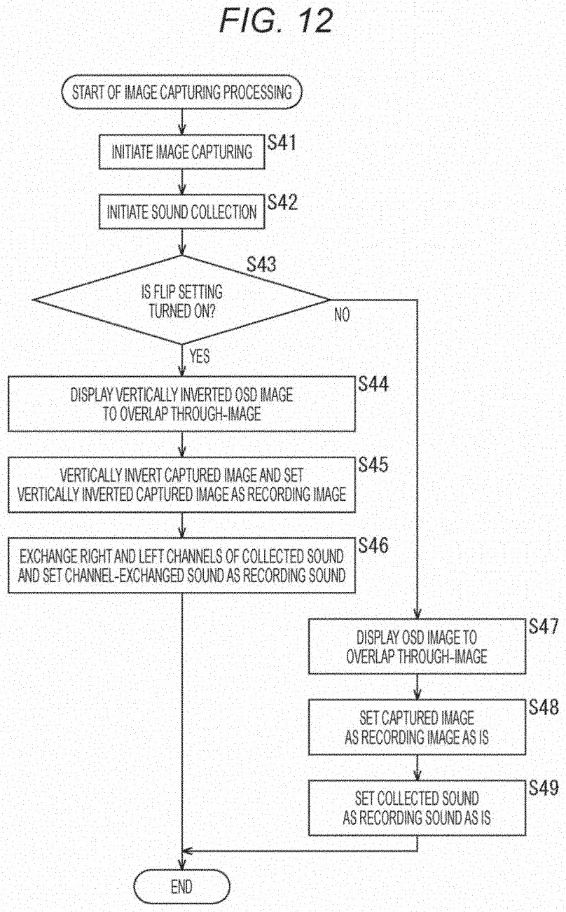

Description will be given of an operation of the imaging device 11 when a moving image is captured. That is, image capturing processing using the imaging device 11 will be described below with reference to the flowchart of FIG. 12.

In step S41, the imaging unit 131 initiates capturing of an image. That is, the imaging unit 131 captures an image of each frame by receiving light incident from a subject and performing photoelectric conversion, and sequentially supplies image data that is acquired to the control unit 133.

In step S42, the sound collection unit 22 initiates collection of ambient sound and sequentially supplies sound data of collected sound to the control unit 133.

In step S43, the control unit 133 determines whether or not flip setting is turned on. For example, in a case where flip setting information recorded in the setting unit 151 is information indicating that flip setting is turned on, it is determined that flip setting is turned on.

In step S43, in a case where it is determined that flip setting is turned on, in step S44, the display control unit 153 displays a vertically inverted OSD image to overlap a through-image.

That is, the display control unit 153 supplies image data of the captured image acquired by the imaging unit 131 as image data of a through-image to the display unit 61 as is, and allows the display unit 61 to display the through-image.

In addition, the display control unit 153 generates image data in which an OSD image is displayed in the vertically inverted state, that is, an OSD image is displayed in the inverted display state on the basis of the image data of the OSD image generated by the OSD image generation unit 152 in accordance with various settings, and sets the generated image data as image data of a final OSD image. Then, the display control unit 153 supplies the generated image data of the OSD image to the display unit 61 and controls the display unit 61 to display the OSD image in the inverted display state to overlap the through-image.

With this arrangement, for example, the through-image and the OSD image which are indicated by an arrow Q31 or indicated by an arrow Q33 in FIG. 11 are displayed on the display unit 61.

In step S45, the recording control unit 154 vertically inverts the captured image and sets the inverted captured image as a recording image.

That is, the recording control unit 154 generates image data for displaying a captured image displayed in the inverted display state, that is, an image displayed in the vertically inverted state as image data for a recording image on the basis of the image data of the captured image supplied from the imaging unit 131.

In step S46, the recording control unit 154 exchanges the right and left channels of collected sound and sets the channel-exchanged sound as recording sound.

That is, the recording control unit 154 generates sound data in which the right and left channels of sound data are exchanged on the basis of the sound data of the collected sound supplied from the sound collection unit 22, and sets the generated sound data as sound data for recording sound.

Through the above-described processing, image data of a recording image and sound data of recording sound for reproducing a moving image are acquired, for example, as indicated by an arrow Q32 or an arrow Q34 in FIG. 11.

When the image data of a recording image and the sound data of recording sound are acquired, for example, the recording control unit 154 supplies the image data and the sound data to the removable recording medium 134 and records the image data and the sound data therein. In addition, for example, the image data of a recording image and the sound data of recording sound may be supplied to the external device 122 through the input/output terminal 136 by the control unit 133.

Then, when the image data of a recording image and the sound data of recording sound are appropriately recorded or the like, the image capturing processing is terminated.

In contrast, in step S43, in a case where it is determined that flip setting is not turned on, that is, flip setting is turned off, the processing proceeds to step S47.

In step S47, the display control unit 153 displays an OSD image to overlap a through-image.

That is, the display control unit 153 supplies image data of the captured image acquired by the imaging unit 131 as image data of a through-image to the display unit 61 as is, and allows the display unit 61 to display the through-image.

In addition, the display control unit 153 supplies the image data of an OSD image, which is generated by the OSD image generation unit 152 in accordance with various settings, to the display unit 61 as is, and controls the display unit 61 to display the OSD image in the normal display state to overlap the through-image.

With this arrangement, for example, the through-image and the OSD image which are indicated by an arrow Q21 or indicated by an arrow Q23 in FIG. 10 are displayed on the display unit 61.

In step S48, the recording control unit 154 sets the captured image as a recording image as is. That is, the recording control unit 154 sets the image data of the captured image supplied from the imaging unit 131 as image data of a recording image as is.

In step S49, the recording control unit 154 sets the collected sound as recording sound as is. That is, the recording control unit 154 sets the sound data of the collected sound supplied from the sound collection unit 22 as sound data of recording sound as is.

Through the above-described processes, image data of a recording image and sound data of recording sound for reproducing a moving image are acquired, for example, as indicated by an arrow Q22 or an arrow Q24 in FIG. 10.

When the image data of a recording image and the sound data of recording sound are acquired, for example, the recording control unit 154 supplies the image data and the sound data to the removable recording medium 134 and records the image data and the sound data therein. In addition, for example, the image data of a recording image and the sound data of recording sound may be supplied to the external device 122 through the input/output terminal 136 by the control unit 133.

Then, when the image data of a recording image and the sound data of recording sound are appropriately recorded and the like, the image capturing processing is terminated.

In this manner, the imaging device 11 generates the recording image and the recording sound depending on whether flip setting is turned on or off. Particularly, when the flip setting is turned on, the captured image is vertically inverted and is set as a recording image, and the right and left channels of the collected sound are exchanged and resultant sound is set as recording sound, and thus it is possible to acquire a recording image and recording sound which are appropriately reproduced even when the imaging device 11 is used in the inverted use state.

<With Regard to Output of Image or the like to Outside>

In addition, when an image or sound acquired by the imaging device 11 is output to the external device 122, outputting of an image or sound is controlled such that various images such as an OSD image are displayed in the normal display state and sound is reproduced rightly without depending on whether flip setting is turned on or off. This is, for example, because a display of the external device 122 is not often used in the vertically inverted state.

Here, when an OSD image or the menu screen is displayed on the external device 122, the imaging device 11 outputs data such as the OSD image and the menu screen to the external device 122 as is to be displayed in the normal display state. In addition, the imaging device 11 outputs the image data of a recording image or the sound data of recording sound to the external device 122 as is such that a moving image is reproduced rightly.

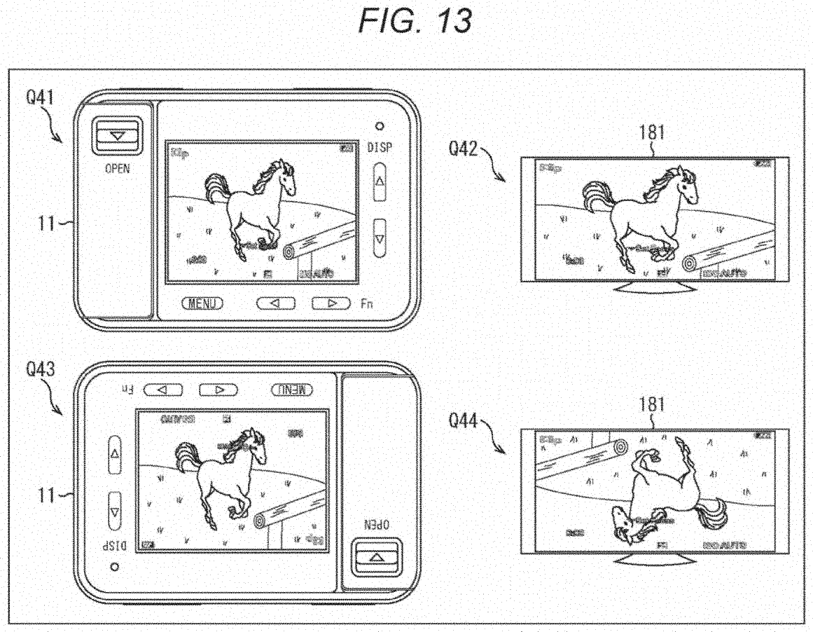

Accordingly, for example, when flip setting is turned off as indicated by an arrow Q41 in FIG. 13, it is assumed that capturing of a moving image is performed in the normal use state and the acquired recording image and recording sound and the OSD image are output to the external device 122 to be displayed thereon.

In this case, as indicated by the arrow Q41, the OSD image or the through-image in the imaging device 11 is seen erectly by a user.

In addition, in this case, as indicated by an arrow Q42, the OSD image and the recording image in the display unit 181 which is a display constituting the external device 122 is seen erectly by a user. That is, in the recording image, a subject is displayed in the same way as a user actually sees the subject.

In contrast, for example, when flip setting is turned off as indicated by an arrow Q43, it is assumed that a moving image is captured in the inverted use state and the acquired recording image and recording sound and the OSD image are output to the external device 122 to be displayed thereon.

In this case, as indicated by the arrow Q43, a subject on a through-image in the imaging device 11 is displayed in the same way as a user actually sees the subject, but the OSD image is displayed in the vertically inverted state to the user.

In addition, in this case, as indicated by an arrow Q44, the OSD image on the display unit 181 of the external device 122 is displayed erectly to a user, but the subject in the recording image is displayed in the vertically inverted state unlike the subject which is actually seen by the user.

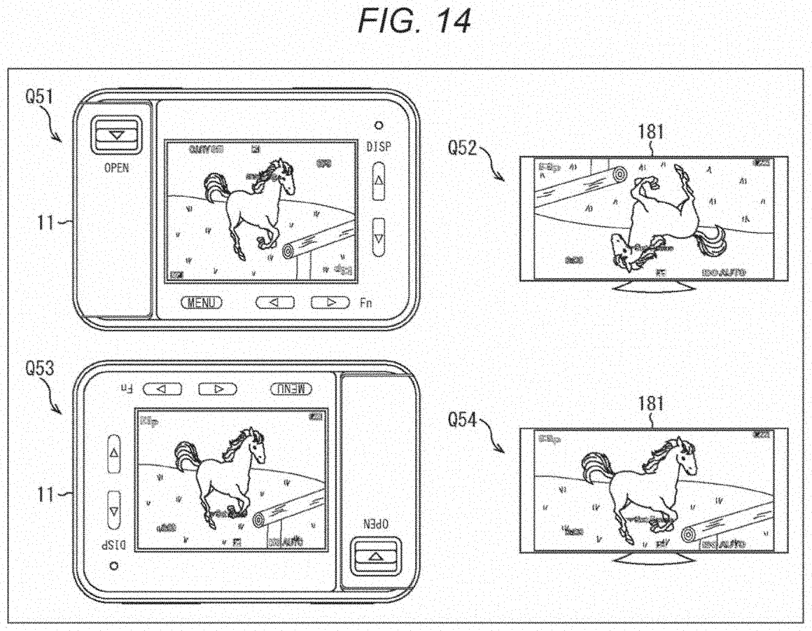

On the other hand, for example, when flip setting is turned on as indicated by an arrow Q51 in FIG. 14, it is assumed that a moving image is captured in the normal use state and the acquired recording image and recording sound and the OSD image are output to the external device 122 to be displayed thereon.

In this case, as indicted by the arrow Q51, a subject on a through-image in the imaging device 11 is displayed in the same way as a user actually sees the subject, but the OSD image is displayed in the vertically inverted state to the user.

In addition, in this case, as indicted by an arrow Q52, the OSD image in the display unit 181 of the external device 122 is displayed erectly to the user, but a subject in the recording image is displayed in the vertical inverted state unlike the subject which is seen by the user.

In contrast, for example, when flip setting is turned on as indicated by an arrow Q53, it is assumed that a moving image is captured in the inverted use state and the acquired recording image and recording sound and the OSD image are output to the external device 122 to be displayed thereon.

In this case, as indicated by the arrow Q53, the OSD image or the through-image in the imaging device 11 is displayed erectly to the user.

In addition, in this case, as indicted by an arrow Q54, the OSD image and the recording image in the display unit 181 of the external device 122 are displayed erectly to the user. That is, a subject in the recording image is displayed in the same way as the subject which is actually seen by the user.

In this manner, when a recording image or recording sound is output to the external device 122 and image capturing is performed in a right use state by the imaging device 11, the OSD image or the recording image in the external device 122 is displayed erectly and the recording sound can be rightly reproduced.

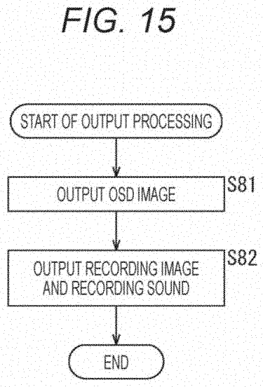

Here, description will be given of processing of causing the imaging device 11 to output an OSD image, a recording image, and recording sound to the external device 122 as described above. That is, output processing by the imaging device 11 will be described below with reference to the flowchart of FIG. 15.

This output processing is performed, for example, when a moving image is being captured by using the imaging device 11, that is, when the image capturing processing described above with reference to FIG. 12 is being performed, when a moving image recorded on the removable recording medium 134 after the image capturing, that is, the recording image and the recording sound are reproduced by the external device 122, or the like.

In step S81, the control unit 133 outputs image data of an OSD image generated by the OSD image generation unit 152 to the external device 122 through the input/output terminal 136 as is. With this arrangement, the OSD image is displayed erectly on the external device 122.

In step S82, the control unit 133 outputs image data of a recording image and sound data of recording sound to the external device 122 through the input/output terminal 136 as is, and the output processing is terminated.

For example, when a moving image is being captured, the image data of a recording image and the sound data of recording sound which are acquired in the processing in step S45 and step S46 in FIG. 12 or the processing in step S48 and step S49 in FIG. 12 are output to the external device 122 in step S82.

In addition, for example, when a moving is not being captured, image data of a recording image and sound data of recording sound which are read from the removable recording medium 134 are output to the external device 122.

The image data of a recording image and the sound data of recording sound which are supplied to the external device 122 are recorded in the external device 122 or are used for reproducing processing in the external device 122. Accordingly, for example, when a recording image is displayed on the display unit 181, a direction of a subject varies depending on the flip setting and the use state of the imaging device 11 as in the example indicated by the arrow Q42 or the arrow Q44 in FIG. 13 or the example indicated by the arrow Q52 or the arrow Q54 in FIG. 14.

As described above, the imaging device 11 outputs the OSD image, the recording image, and the recording sound to the external device 122 as is without depending on whether flip setting is turned on or off.

Accordingly, when an image is captured in the right use state by the imaging device 11 and an image of a subject is displayed on the display unit 181 of the external device 122 for confirmation of an angle of view and the like, for example, during capturing a moving image, the OSD image or the recording image is displayed erectly on the external device 122 and the recording sound can also be rightly reproduced. With this arrangement, it is possible to improve convenience.

<With Regard to Operation of Direction Key>

In addition, behavior of the direction keys serving as the operation unit 132 in the imaging device 11 varies depending on whether flip setting is turned on or off.

That is, in the state in which flip setting is turned off, the upward operation function and the DISP function are allocated to the upward button 63, and the downward operation function and another selected function are allocated to the downward button 64. Furthermore, in the following description, it is assumed that a reproduction function is allocated to the downward button 64 as another selected function.

When flip setting is turned on in this state, the allocated functions of the upward button 63 and the downward button 64 associated with opposite directions are exchanged with each other.

That is, in the state in which flip setting is turned on, the downward operation function and the reproduction function are allocated to the upward button 63, and the upward operation function and the DISP function are allocated to the downward button 64.

In this case, for example, characters “DISP” are printed in the vicinity of the upward button 63 as illustrated in FIG. 3, but when the upward button 63 is operated, processing of realizing the reproduction function instead of the DISP function is performed. That is, when flip setting is turned on and the upward button 63 disposed in the vicinity of characters “DISP” is operated, the control unit 133 does not perform the processing of realizing the DISP function indicated by the characters “DISP”, and performs processing of realizing the reproduction function which is different from the processing of realizing the DISP function.

In addition, in the state in which flip setting is turned off, the leftward operation function and another selected function are allocated to the leftward button 65, and the rightward operation function and the Fn function are allocated to the rightward button 66. Furthermore, in the following description, it is assumed that a WB setting function is allocated to the leftward button 65 as another selected function.

When flip setting is turned on in this state, the allocated functions of the leftward button 65 and the rightward button 66 associated with opposite directions are exchanged with each other.

That is, in the state in which flip setting is turned on, the rightward operation function and the Fn function are allocated to the leftward button 65, and the leftward operation function and the WB setting function are allocated to the rightward button 66.

In this case, for example, characters “Fn” are printed in the vicinity of the rightward button 66 as illustrated in FIG. 3, but when the rightward button 66 is operated, processing of realizing the WB setting function instead of the Fn function is performed. That is, even when the rightward button 66 is operated, the processing of realizing the Fn function is not performed.

With regard to the direction keys associated with a direction, when flip setting is turned on, the allocated functions of the direction keys are exchanged between the direction keys associated with the opposite directions, that is, between a direction key associated with a predetermined direction and a direction key associated with a direction opposite to the predetermined direction. In other words, an allocation destination of a function is changed.

At this time, allocation destinations of the functions associated with no direction such as the DISP function, the Fn function, and the WB setting function in addition to the functions associated with a direction such as the upward operation function and the like, that is, the functions of realizing an operation associated with a direction are exchanged.

Furthermore, with regard to a button (a key) associated with no direction, the allocated function of the button is not changed without depending on whether flip setting is turned on or off.

For example, the menu button 67, the power supply button 41, and the shutter button 42 are buttons (the operation units) which are not associated with a direction, and the allocated functions of these buttons are not exchanged without depending on whether flip setting is turned on or off. That is, an allocated function of an operation unit which is not associated with a direction such as the menu button 67 is not changed.

Accordingly, a menu display function is allocated to the menu button 67, for example, without depending on whether flip setting is turned on or off.

As described above, by exchanging the allocated functions of the direction keys associated with the opposite directions when flip setting is turned on, a user can operate a key, when the user uses the imaging device 11 in the inverted use state, with the same operating sense as when the imaging device 11 is used in the normal use state. With this arrangement, it is possible to improve convenience of the imaging device 11.

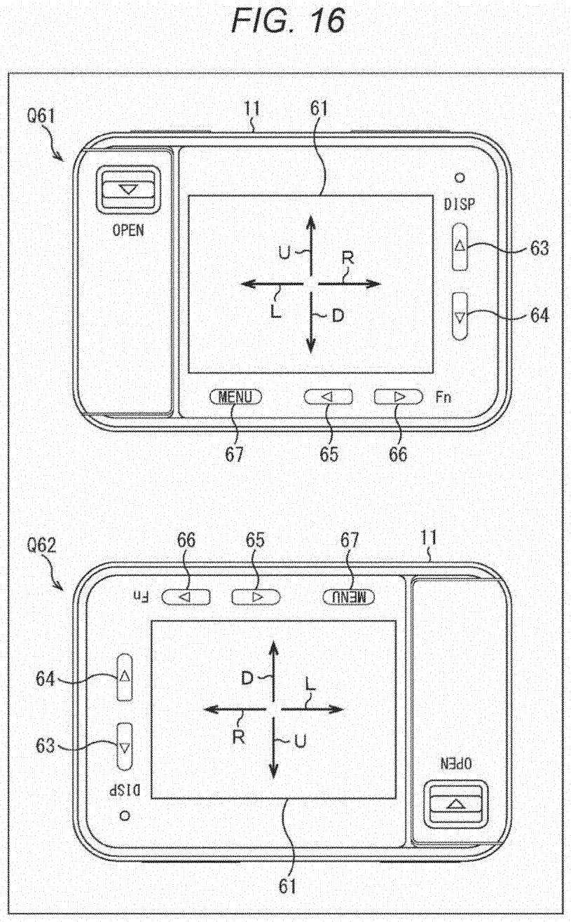

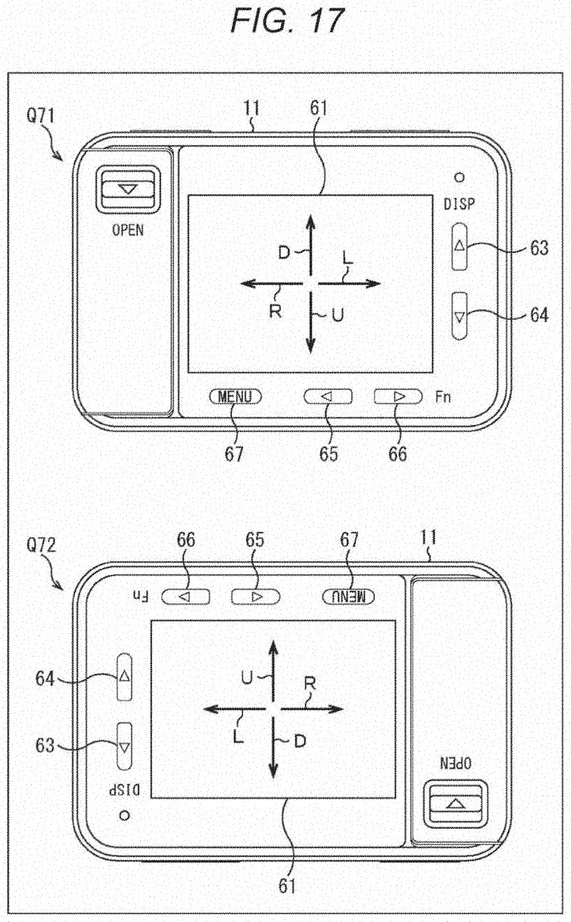

Accordingly, behavior of the imaging device 11 when the direction keys are operated, for example, as indicated by FIG. 16 and FIG. 17 varies depending on whether flip setting is turned on or off or the use state of the imaging device 11.

Furthermore, in FIG. 16 and FIG. 17, the same reference numeral will be given to a portion corresponding to FIG. 3, and description thereof will be appropriately omitted. In addition, in FIG. 16 and FIG. 17, an arrow U, an arrow D, an arrow L, and an arrow R denote the screen upward direction, the screen downward direction, the screen leftward direction, and the screen rightward direction, respectively.

For example, when flip setting is turned off and a user operates the direction keys in the normal use state as indicated by an arrow Q61 in FIG. 16, the operation is performed in the directions of the functions allocated to the direction keys in initial setting and in the same directions as seen from the user. Here, allocation of a function to each direction key in the initial setting refers to allocation of a function in the state in which flip setting is turned off.

When the upward button 63, the downward button 64, the leftward button 65, and the rightward button 66 are operated, the upward, downward, leftward, and rightward operations in FIG. 16 are performed. In addition, in the example indicated by the arrow Q61, the upward, downward, leftward, and rightward directions in the drawing are the screen upward direction, the screen downward direction, the screen leftward direction, and the screen rightward direction, respectively.

Accordingly, for example, when a user operates the upward button 63 in a state in which a cursor is displayed on the display unit 61, the cursor moves in the upward direction which is a direction of an arrow printed in the upward button 63 in the drawing. In addition, in the drawing, the upward direction is a direction toward the top end of the screen displayed on the display unit 61, that is, the screen upward direction.

In addition, for example, when flip setting is turned off and a user operates the direction keys in the inverted use state as indicated by an arrow Q62 in FIG. 16, the operation is performed in the directions of the functions allocated to the direction keys in initial setting and in the same directions as seen from the user.

That is, when the upward button 63, the downward button 64, the leftward button 65, and the rightward button 66 are operated, the downward, upward, rightward, and leftward operations in FIG. 16 are performed. Here, in the example indicated by the arrow Q62, the upward, downward, leftward, and rightward directions in the drawing are the screen downward direction, the screen upward direction, the screen rightward direction, and the screen leftward direction, respectively.

Accordingly, for example, when a user operates the upward button 63 in a state in which a cursor is displayed on the display unit 61, the cursor moves in the downward direction which is a direction of an arrow printed in the upward button 63 in the drawing. In addition, in the example indicated by the arrow Q62, the downward direction in the drawing is a direction toward the top end of the screen displayed on the display unit 61, that is, the screen upward direction.

In addition, when flip setting is turned on, the allocated functions of the upward button 63 and the downward button 64 are exchanged and the allocated functions of the leftward button 65 and the rightward button 66 are exchanged.

Accordingly, for example, when flip setting is turned on and a user operates the direction keys in the normal use state as indicated by an arrow Q71 in FIG. 17, allocation of the functions to the direction keys is different from that when flip setting is turned off, but the operation is performed in the same directions as seen from the user.

That is, when the upward button 63, the downward button 64, the leftward button 65, and the rightward button 66 are operated, the upward, downward, leftward, and rightward operations in FIG. 17 are performed. In addition, in the example indicated by the arrow Q71, the upward, downward, leftward, and rightward directions in the drawing are the screen downward direction, the screen upward direction, the screen rightward direction, and the screen leftward direction, respectively.

Accordingly, for example, when a user operates the upward button 63 in a state in which a cursor is displayed on the display unit 61, the cursor moves in the upward direction that is a direction of an arrow printed in the upward button 63 in the drawing. Here, in the drawing, the upward direction is a direction toward the bottom end of the screen displayed on the display unit 61, that is, the screen downward direction.

When flip setting is turned on in this manner, the function of the operation associated with the downward direction opposite to the upward direction with the display screen set as a reference, that is, the screen downward direction, on the display screen is allocated to the upward button 63 associated with the upward direction, and the functions are allocated to the other direction keys in a similar manner.

In addition, for example, when flip setting is turned on and a user operates the direction keys in the inverted use state as indicated by an arrow Q72 in FIG. 17, allocation of the functions to the direction keys is different from that when flip setting is turned off, but the operation is performed in the same directions as seen from the user.

That is, when the upward button 63, the downward button 64, the leftward button 65, and the rightward button 66 are operated, the downward, upward, rightward, and leftward operations in FIG. 17 are performed. Here, in the example indicated by the arrow Q72, the upward, downward, leftward, and rightward directions in the drawing are the screen upward direction, the screen downward direction, the screen leftward direction, and the screen rightward direction, respectively.

Accordingly, for example, when a user operates the upward button 63 in a state in which a cursor is displayed on the display unit 61, the cursor moves in the downward direction which is a direction of an arrow printed in the upward button 63 in the drawing. In addition, in the example indicated by the arrow Q72, the downward direction in the drawing is a direction toward the bottom end of the screen displayed on the display unit 61, that is, the screen downward direction.

In the state in which flip setting is turned on in this manner, the functions allocated to the direction keys are exchanged.

Accordingly, a direction of an operation performed when a user operates a direction key is opposite to the direction associated with the direction key when the screen such as the menu screen or the recording image is set as a reference. That is, for example, when the upward button 63 associated with the upward direction is operated, the operation associated with the downward direction, that is, the screen downward direction with respect to the display screen is performed.

However, when flip setting is turned on, the display screen is vertically inverted and displayed, that is, the display direction is vertically inverted. Accordingly, when a user operates the direction keys, the operation is performed in the directions of the arrows printed in the direction keys. That is, the operation is performed in the same directions as seen from the user.

Accordingly, a user can perform an operation with an operating sense similar to an operating sense when flip setting is turned off and it is thus possible to improve convenience of the imaging device 11.

In addition, in the state in which flip setting is turned on, the functions of the operations associated with no direction are exchanged between the direction keys.

Accordingly, even when a user turns on the flip setting and uses the imaging device 11 in the inverted use state, the user can perform an operation with the same operating sense as when the flip setting is turned off and the imaging device 11 is used in the normal use state and it is thus possible to further improve convenience.

Specifically, for example, when the flip setting is turned off as in the example indicated by the arrow Q61 in FIG. 16 and the upward button 63 in which an upward arrow when seen by the user is printed is operated during capturing of a moving image or during reproduction of a recording medium in the normal use state, the DISP function is performed.

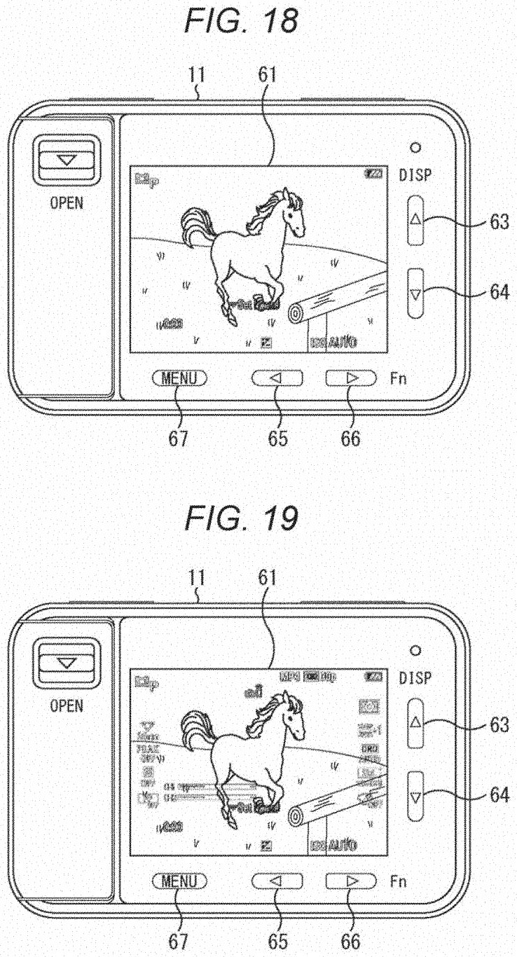

That is, when the upward button 63 to which the DISP function is allocated is operated by the user, display on the display unit 61 of the imaging device 11 is switched as illustrated in FIG. 18 to FIG. 20.

For example, in the example illustrated in FIG. 18, an OSD image including minimum necessary information such as an image capturing mode or an amount of power remaining in a battery is displayed on the display unit 61.

In addition, in the example illustrated in FIG. 19, an OSD image including more pieces of information in comparison to the OSD image illustrated in FIG. 18 such as a photometry mode and setting of white balance adjustment is displayed on the display unit 61.

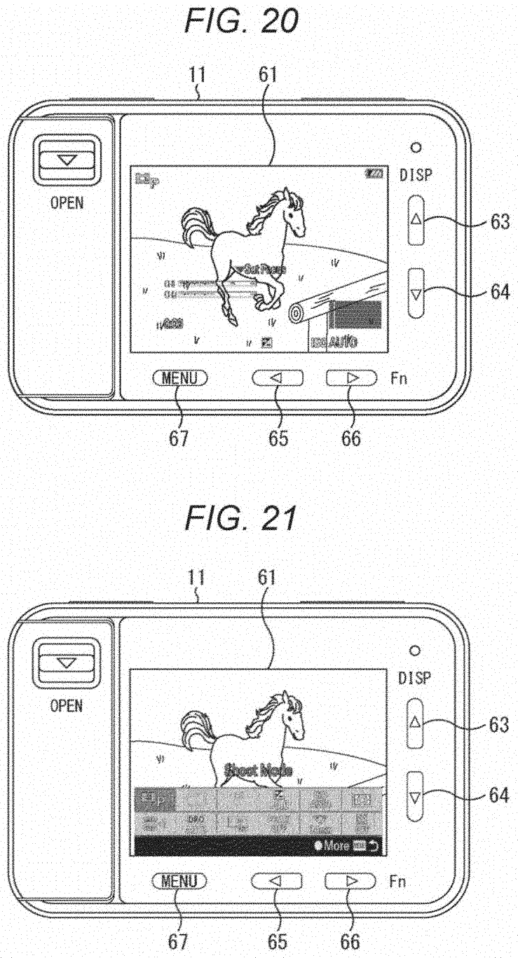

Furthermore, in the example illustrated in FIG. 20, in addition to the similar minimum necessary information to the OSD image illustrated in FIG. 18, an OSD image including some pieces of information including a luminance histogram of a through-image or a recording image is displayed on the display unit 61.

Whenever a user operates the upward button 63 to which the DISP function is allocated, the display on the display unit 61 is switched, for example, from the display illustrated in FIG. 18 to the display illustrated in FIG. 19, and is further switched to the display illustrated in FIG. 20. In this manner, switching of the display is performed.

At this time, since characters “DISP” are printed in the vicinity of the upward button 63 to which the DISP function is allocated, a user can easily switch the display.

In contrast, for example, when the flip setting is turned on as in the example indicated by the arrow Q72 in FIG. 17 and the downward button 64 in which an upward arrow when seen by the user is printed is operated during capturing of a moving image or during reproduction of a recording medium in the inverted use state, the DISP function is performed.

As described above, the direction key (the button) to which the DISP function is allocated varies depending on whether the flip setting is turned on or off. However, in any case, when a user who uses the imaging device 11 in the use state assumed with respect to the flip setting operates the direction key in which an upward arrow is printed when seen from the user, the DISP function can be performed. That is, a user can perform the operation for the DISP function with the same operating sense without depending on the flip setting.

Similarly to the DISP function, a user can perform the operation for the reproduction function with the same operating sense without depending on whether the flip setting is turned on or off.

That is, for example, when the flip setting is turned off as in the example indicated by the arrow Q61 in FIG. 16 and the imaging device is used in the normal use state, a user can give an instruction for execution of the reproduction function by operating the downward button 64 in which the downward arrow is printed when seen from the user.

In contrast, for example, when the flip setting is turned on as in the example indicated by the arrow Q72 in FIG. 17 and the imaging device is used in the inverted use state, a user can give an instruction for execution of a reproduction function by operating the upward button 63 in which the downward arrow is printed when seen from the user.

In addition, with regard to the leftward button 65 and the rightward button 66 as well as the upward button 63 and the downward button 64, a user can perform the operation with the similar operating sense without depending on the flip setting.

That is, for example, when the flip setting is turned off as in the example indicated by the arrow Q61 in FIG. 16 and a user operates the rightward button 66 during capturing of a moving image in the normal use state, the Fn function allocated to the rightward button 66 is performed.

Specifically, when the rightward button 66 is operated, for example, a function setting screen illustrated in FIG. 21 is displayed on the display unit 61. In this example, various settings such as an image capturing mode, an exposure, an ISO sensitivity, a photometry mode, and white balance adjustment can be performed on the function setting screen.

In contrast, for example, when the flip setting is turned on as in the example indicated by the arrow Q72 in FIG. 17 and the imaging device is used in the inverted use state, a user can display the function setting screen illustrated in FIG. 21 on the display unit 61 by operating the leftward button 65. That is, the Fn function can be performed.

In this manner, without depending on whether the flip setting is turned on or off, a user can give an instruction for execution of the Fn function by operating the direction key (the button) in which the rightward arrow is printed when seen from the user.

Furthermore, for example, when the flip setting is turned off as in the example indicated by the arrow Q61 in FIG. 16 and a user operates the leftward button 65 during capturing of a moving image or the like in the normal use state, the WB setting function allocated to the leftward button 65 is performed.

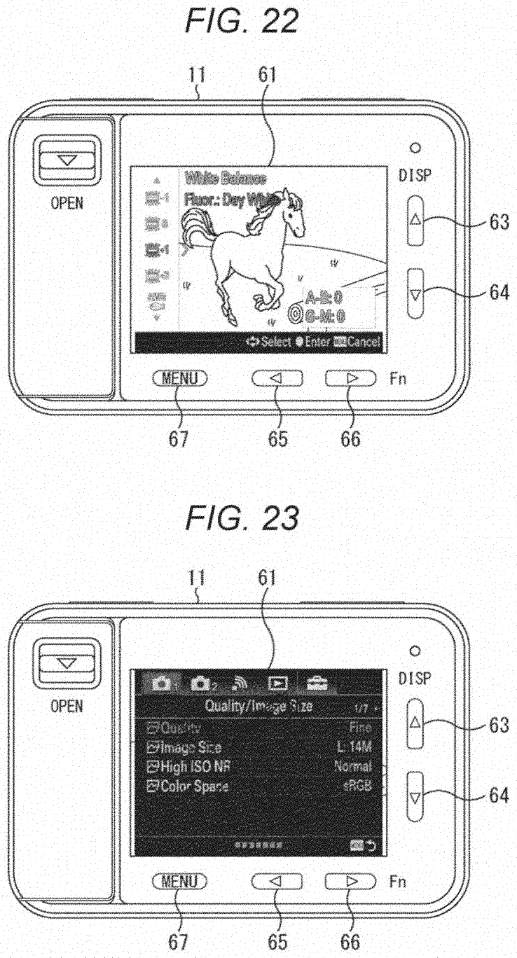

Specifically, when the leftward button 65 is operated, for example, a WB setting screen illustrated in FIG. 22 is displayed on the display unit 61. In this example, an image capturing environment in white balance adjustment such as a clear sky, a fluorescent light, and automation can be set on the WB setting screen.

In contrast, for example, when the flip setting is turned on as in the example indicated by the arrow Q72 in FIG. 17 and the imaging device is used in the inverted use state, a user can display the WB setting screen illustrated in FIG. 22 on the display unit 61 by operating the rightward button 66. That is, the WB setting function can be performed. However, in this case, since the flip setting is turned on, the WB setting screen is displayed in the inverted display state.

As described above, without depending on whether the flip setting is turned on or off, a user can give an instruction for execution of the WB setting function by operating the direction key (the button) in which the leftward arrow is printed when seen from the user.

Furthermore, as described above, the allocated function of a button associated with no direction such as the menu button 67 is not changed even when the flip setting is turned on.

Accordingly, when the menu button 67 is operated by a user, for example, the menu screen illustrated in FIG. 23 is displayed on the display unit 61 without depending on whether the flip setting is turned on or off.

A user can perform various settings by performing an operation such as selection and determination on the menu screen displayed as described above. For example, in the example illustrated in FIG. 23, a user can perform setting of the quality of a recording image, setting of the size of a recording image, and the like.

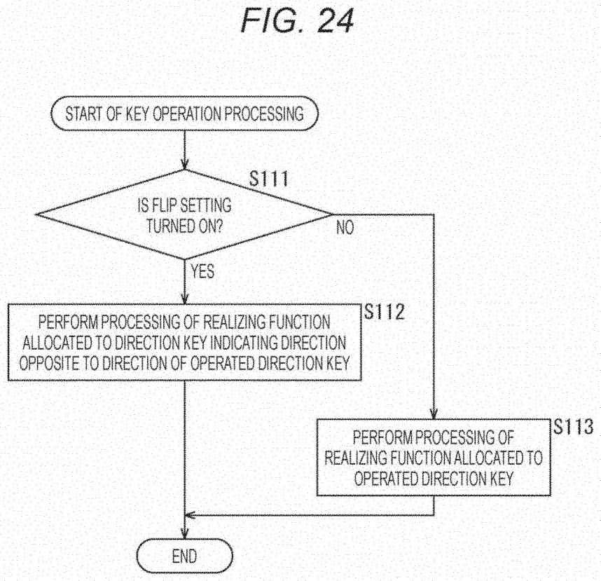

Here, description will be given of key operation processing of causing the imaging device 11 to perform processing corresponding to an operation when the direction keys are operated as described above. That is, the key operation processing performed by the imaging device 11 will be described below with reference to the flowchart of FIG. 24.

The key operation processing is initiated, for example, when one direction key of the imaging device 11 is operated by a user. When a direction key serving as the operation unit 132 is operated by a user, a signal corresponding to the user's operation is supplied from the operation unit 132 to the control unit 133.

In step S111, the control unit 133 determines whether or not the flip setting is turned on on the basis of the flip setting information recorded in the setting unit 151.

In step S111, in a case where it is determined that the flip setting is turned on, the processing proceeds to step S112.

In step S112, the control unit 133 performs processing of realizing the function which is allocated in advance to the direction key associated with a direction opposite to the direction of the operated direction key on the basis of a signal based on a user's operation and supplied from the operation unit 132 and the determination result of step S111. Here, the function allocated in advance represents a function allocated in an initial set state, that is, in a state in which the flip setting is turned off.

In other words, in step S112, the control unit 133 exchanges the allocated functions of the direction keys on the basis of the determination result of step S111. In addition, the control unit 133 performs processing of realizing the function which is allocated after the allocated functions have been exchanged on the direction key which is operated by the user on the basis of a signal supplied from the operation unit 132.

Accordingly, for example, it is assumed that the upward button 63 is operated by the user in a state in which the menu screen is displayed on the display unit 61.

In this case, the control unit 133 specifies the downward button 64 associated with the downward direction which is opposite to the upward direction associated with the upward button 63 which is operated by the user, and performs processing of realizing the downward operation function which is allocated to the downward button 64 in the state in which the flip setting is turned off. That is, the display control unit 153 of the control unit 133 controls the display unit 61 to move the cursor displayed on the menu screen in the screen downward direction.

When the flip setting is turned on, processing of a function based on the allocation when the flip setting is turned on can be performed by performing the allocated function allocated to the direction key which is opposite to the direction of the operated direction key in the state in which the flip setting is turned off.

When the processing based on the operation of the direction key is performed in this manner, the key operation processing is terminated.

On the other hand, in step S111, in a case where it is determined that the flip setting is not turned on, that is, the flip setting is turned off, the processing proceeds to step S113.

In step S113, the control unit 133 performs processing of realizing the function allocated in advance to the operated direction key on the basis of a signal that is based on the user's operation and is supplied from the operation unit 132, and the determination result of step S111, and the key operation processing is terminated.

In this case, the control unit 133 performs processing of the function allocated to the operated direction key in the state in which the flip setting is turned off. Accordingly, for example, when the upward button 63 is operated by the user in the state in which the menu screen is displayed on the display unit 61, the display control unit 153 of the control unit 133 controls the display unit 61 to move the cursor displayed on the menu screen in the screen upward direction.

As described above, the imaging device 11 performs the processing based on the operation of the direction key on the basis of the flip setting and the function allocated in advance to the direction key. That is, the imaging device 11 exchanges the functions of the direction keys depending on the flip setting and performs the processes based on the operations of the direction keys. Accordingly, a user can be allowed to perform an operation with the same operating sense without depending on the flip setting, and thus it is possible to improve convenience of the imaging device 11.

Furthermore, description has been given of an example in which the functions allocated to the direction keys associated with the opposite directions are exchanged. This is because it is assumed that the imaging device 11 is used in the inverted use state.

However, for example, it is conceivable that the imaging device 11 is used in a state in which it is rotated by 90 degrees in the clockwise direction or the counterclockwise direction with an optical axis of the imaging device 11 set as a rotation axis. Setting based on such assumption of use may be performed through the flip setting.

In this case, for example, when it is assumed that the imaging device 11 is used in the state in which it is rotated by 90 degrees, for example, a function allocated in advance to the rightward button 66 may be allocated to the upward button 63 and a function allocated in advance to the downward button 64 may be allocated to the rightward button 66. That is, a function allocated in advance to a direction key associated with a predetermined direction may be allocated to a direction key associated with a direction forming a predetermined angle such as 90 degrees with respect to the predetermined direction. When the allocated functions of four direction keys are exchanged as described above, a user can be allowed to perform an operation with the similar operating sense to in the normal use state even when the imaging device 11 is used in the state in which it is rotated by 90 degrees.

<With Regard to Operation in Remote Operation Device>

Incidentally, when a user remotely operates the imaging device 11 with the remote operation device 121 that is an external device, the user operates the remote operation device 121 while seeing the menu screen and the like which are displayed on the display unit 61.

At this time, a command based on the user's operation of the remote operation device 121 is transmitted from the remote operation device 121 to the imaging device 11, and the imaging device 11 executes the command received from the remote operation device 121 without depending on whether the flip setting is turned on or off.

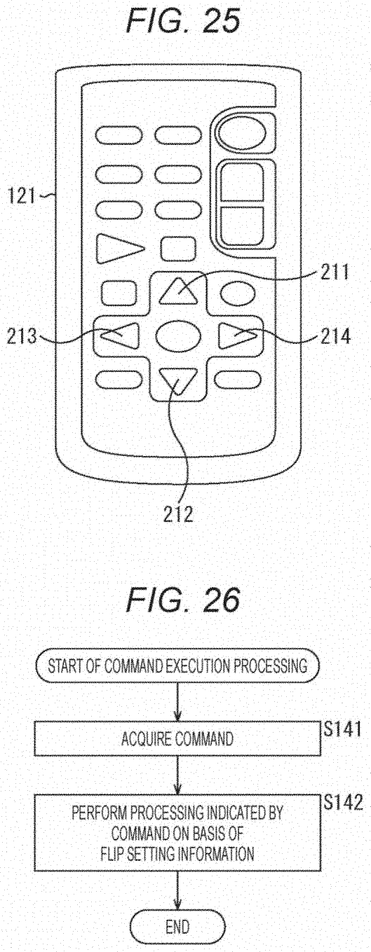

For example, it is assumed that an upward button 211, a downward button 212, a leftward button 213, and a rightward button 214 are provided in the remote operation device 121 as illustrated in FIG. 25. Furthermore, FIG. 25 illustrates a configuration example of an external appearance of the remote operation device 121.

The upward button 211 is a button to which the upward operation function and the DISP function are allocated and corresponds to the upward button 63 of the imaging device 11.

In addition, the downward button 212 is a button to which the downward operation function and another selected function are allocated and corresponds to the downward button 64 of the imaging device 11. Here, it is assumed that the reproduction function is allocated as another selected function to the downward button 212.

The leftward button 213 is a button to which the leftward operation function and another selected function are allocated and corresponds to the leftward button 65 of the imaging device 11. Here, it is assumed that the WB setting function is allocated as another selected function to the leftward button 213.

The rightward button 214 is a button to which the rightward operation function and the Fn function are allocated and corresponds to the rightward button 66 of the imaging device 11.

The upward button 211, the downward button 212, the leftward button 213, and the rightward button 214 are buttons (direction keys) associated with the upward, downward, leftward, and rightward directions, respectively, in a similar manner as in the direction keys of the imaging device 11.

Particularly, in the remote operation device 121, since the upward button 211, the downward button 212, the leftward button 213, and the rightward button 214 are disposed on the upper, lower, left, and right sides when seen from the user, the user can intuitively understand what directions the buttons (the direction keys) are associated with on the basis of the disposed positions thereof.

For example, it is assumed that the flip setting is turned off as indicated by the arrow Q61 in FIG. 16 and a user operates one direction key of the remote operation device 121 in the state in which the imaging device 11 is used in the normal use state. In this case, an operation is performed in the direction of the function allocated to the direction key and in the same direction as seen from the user.

That is, when the upward button 211, the downward button 212, the leftward button 213, and the rightward button 214 are operated, operations in the upward, downward, leftward, and rightward directions in FIG. 16 are performed. In the example indicated by the arrow Q61, the upward, downward, leftward, and rightward directions in the drawing are the screen upward direction, the screen downward direction, the screen leftward direction, and the screen rightward direction, respectively.

In addition, for example, when the flip setting is turned off as indicated by the arrow Q62 in FIG. 16 and a user operates one direction key of the remote operation device 121 in the state in which the imaging device 11 is used in the inverted use state, an operation is performed in the direction of the function allocated to the direction key but in the direction opposite to the direction seen from the user.

That is, when the upward button 211, the downward button 212, the leftward button 213, and the rightward button 214 are operated, the operations in the downward, upward, rightward, and leftward directions in FIG. 16 are performed. In this manner, in the example indicated by the arrow Q62, a user's operation of a direction key is seen as if an operation is performed in a direction opposite to the direction seen from the user.

However, in the example indicated by the arrow Q62, since the upward, downward, leftward, and rightward directions in the drawing are the screen downward direction, the screen upward direction, the screen rightward direction, and the screen leftward direction, respectively, processing is actually performed as the remote operation device 121 is operated.

In a similar manner, for example, when the flip setting is turned on as indicated by the arrow Q71 in FIG. 17 and a user operates one direction key of the remote operation device 121 in the state in which the imaging device 11 is used in the normal use state, an operation is performed in the direction of the function allocated to the direction key but in the direction opposite to the direction seen from the user.

That is, when the upward button 211, the downward button 212, the leftward button 213, and the rightward button 214 are operated, the operations in the downward, upward, rightward, and leftward directions in FIG. 17 are performed.

In contrast, for example, when the flip setting is turned on as indicated by the arrow Q72 in FIG. 17 and a user operates one direction key of the remote operation device 121 in the state in which the imaging device 11 is used in the inverted use state, an operation is performed in the direction of the function allocated to the direction key and in the same direction as seen from the user.

That is, when the upward button 211, the downward button 212, the leftward button 213, and the rightward button 214 are operated, operations in the upward, downward, leftward, and rightward directions in FIG. 17 are performed. In the example indicated by the arrow Q72, since the upward, downward, leftward, and rightward directions in the drawing are the screen upward direction, the screen downward direction, the screen leftward direction, and the screen rightward direction, respectively, processing is actually performed in the same directions as seen from the user as the remote operation device 121 is operated.

Furthermore, the operations associated with the in-plane direction of the display screen have been described herein, and other functions allocated to the direction keys of the remote operation device 121 are not exchanged. Accordingly, for example, when a user operates the upward button 211 during capturing of an image or during reproduction of an image, the processing of realizing the DISP function is performed without depending on whether the flip setting in the imaging device 11 is turned on or off.

By prohibiting exchange of a function such as inversion of a direction with respect to an operation on the remote operation device 121 unlike the direction keys of the main body of the imaging device 11 as described above, a user can be allowed to perform an operation with the same operating sense without depending on the flip setting.

That is, when a user who uses the imaging device 11 in a use state in which the flip setting is assumed operates a direction key of the remote operation device 121 without depending on whether the flip setting is turned on or off, an operation in the direction of the direction key is performed in the imaging device 11. Accordingly, it is possible to perform an operation without giving discomfort to a user and to improve convenience.

For example, regarding the imaging device 11, the imaging device 11 is assumed to be used in the inverted use state when the flip setting is turned on, that is, the imaging device 11 is assumed to be used in the vertically inverted state. Accordingly, when the allocated functions of the direction keys associated with opposite directions are exchanged therebetween, the convenience thereof is more excellent.

In contrast, with regard to the remote operation device 121, no user uses the remote operation device 121 in the vertically inverted state without depending on whether the flip setting is turned on or off. Accordingly, when the functions allocated to the direction keys of the remote operation device 121 are not exchanged, the convenience thereof is more excellent.

Furthermore, in this case, since the upward, downward, leftward, and rightward directions on a display screen of the menu screen, a recording image, or the like can be specified with reference to the flip setting information in the imaging device 11, a command from the remote operation device 121 can be rightly executed on the basis of the specifying result.

When executing a command with reference to the flip setting information on the imaging device 11 side in this manner, an operation can be performed on the remote operation device 121 side without worrying about ON and OFF of the flip setting.

Furthermore, here, description has been given of the behavior of the imaging device 11 when the direction keys of the remote operation device 121 are operated, but even when the imaging device 11 is remotely operated using a remote operation device 123 for an external device, the behavior of the imaging device 11 is similar to behavior when the remote operation device 121 is operated.

In this case, for example, a menu screen or a recording image which is supplied from the display control unit 153 of the imaging device 11 through the input/output terminal 136 is displayed on the display unit 181 of the external device 122. Then, a user operates the direction keys or the like of the remote operation device 123 for an external device while seeing the display unit 181 on which the menu screen or the like is displayed.

Then, a command based on the user's operation is transmitted from the remote operation device 123 for an external device, and this command is received by the external device 122. The external device 122 supplies the command received from the remote operation device 123 for an external device in this manner to the control unit 133 through the input/output terminal 136, and the control unit 133 supplied with the command executes the command.

When the command is executed in this manner, the menu screen or the like which is supplied from the display control unit 153 to the display unit 181 of the external device 122 through the input/output terminal 136 includes the execution result of the command.

Here, description will be given of command execution processing of causing the imaging device 11 to execute a command received from the remote operation device 121 or the remote operation device 123 for an external device as described above. That is, the command execution processing performed by the imaging device 11 will be described below with reference to the flowchart of FIG. 26. Furthermore, when the command execution processing is performed, the display control unit 153 of the control unit 133 in the imaging device 11 performs control such that a display screen is displayed in the normal display state or the inverted display state on the basis of the flip setting information.

In step S141, the control unit 133 acquires a command output from the remote operation device 121 which is an external device or the remote operation device 123 for an external device.

For example, the control unit 133 acquires the command that is transmitted from the remote operation device 121 and is received by the communication unit 135 from the communication unit 135. In addition, for example, the control unit 133 acquires a command, which is transmitted from the remote operation device 123 for an external device, from the external device 122 through the input/output terminal 136.

In step S142, the control unit 133 performs processing indicated by the acquired command on the basis of the flip setting information recorded in the setting unit 151 and the command execution processing is terminated. That is, the control unit 133 executes the command which is output from the remote operation device 121 or the remote operation device 123 for an external device on the basis of the setting of the flip function.

For example, when a command for giving an instruction for an operation of the upward button 211 or the like in a predetermined direction with the remote operation device 121 set as a reference is received, the control unit 133 performs control such that an operation associated with the predetermined direction is performed on the display screen. Specifically, for example, it is assumed that a user operates the upward button 211 of the remote operation device 121 to give an instruction for an operation associated with the upward direction with respect to the remote operation device 121, a command based on the operation is acquired, and information indicating that the flip setting is turned on is recorded as the flip setting information in the setting unit 151.

In this case, for example, when the menu screen is displayed in the inverted display state on the display unit 61, the display control unit 153 of the control unit 133 performs processing of moving a cursor on the menu screen in the screen upward direction with the menu screen set as a reference, and selecting a menu item using the cursor as processing indicated by the command. At this time, since the display control unit 153 can specify that the direction towardthe bottom surface of the imaging device 11 is the screen upward direction by referring to the flip setting information, it is possible to move the cursor in the right direction indicated by the command.

In addition, for example, it is assumed that a user operates the upward button 211 of the remote operation device 121, a command based on the operation is acquired, and information indicating that the flip setting is turned off is recorded as the flip setting information in the setting unit 151.

In this case, for example, when the menu screen is displayed in the normal display state on the display unit 61, the display control unit 153 of the control unit 133 performs processing of moving a cursor on the menu screen in the screen upward direction with the menu screen set as a reference, and selecting a menu item using the cursor as processing indicated by the command.

Furthermore, for example, when a command for giving an instruction for an operation in a predetermined direction is received in the state in which an image under reproduction or the like is displayed on the display unit 61 in addition to the state in which the menu screen is displayed, control is performed such that an operation associated with the predetermined direction such as a scrolling operation is performed with the display screen set as a reference.

Furthermore, for example, it is assumed that a user operates the upward button 211 of the remote operation device 121 and a command based on the operation is acquired. In this case, for example, when a moving image is being captured or a recording image is being reproduced, the display control unit 153 of the control unit 133 controls the display unit 61 such that processing of realizing the DISP function is performed as processing indicated by the command. Specifically, for example, processing of switching the display which has been described above with reference to FIG. 18 to FIG. 20 is performed as the processing of realizing the DISP function.

In this manner, for example, when a command for giving an instruction for an operation associated with a predetermined direction, that is, an operation in the predetermined direction, such as the upward operation function is acquired, the control unit 133 specifies whether the display screen is displayed in the vertically inverted or the like with reference to the flip setting information. Then, the control unit 133 executes the acquired command such that the operation associated with the predetermined direction is performed with the display screen set as a reference, that is, such that the operation in the predetermined direction is performed with the display screen set as a reference.

On the other hand, for example, when a command for giving an instruction for an operation associated with no direction such as the DISP function is acquired, the control unit 133 executes the command as is such that the operation associated with no direction is performed without depending on when the flip setting is turned on or off. That is, control is performed such that the operation associated with no direction is performed.

As described above, the imaging device 11 acquires a command output from the remote operation device 121 or the remote operation device 123 for an external device and executes the command on the basis of the flip setting information.

By executing the command on the basis of the flip setting information in this manner, the remote operation device 121 or the remote operation device 123 for an external device can perform an operation without worrying about ON and OFF of the flip setting and thus it is possible to improve the convenience.

<Configuration Example of Computer>

The above-described series of processing may be executed by hardware or software. In a case of performing the series of processing by software, a program that constitutes the software is installed in a computer. Here, examples of the computer include a computer provided with exclusive hardware, a general-purpose computer capable of executing various functions by installing various programs, and the like.

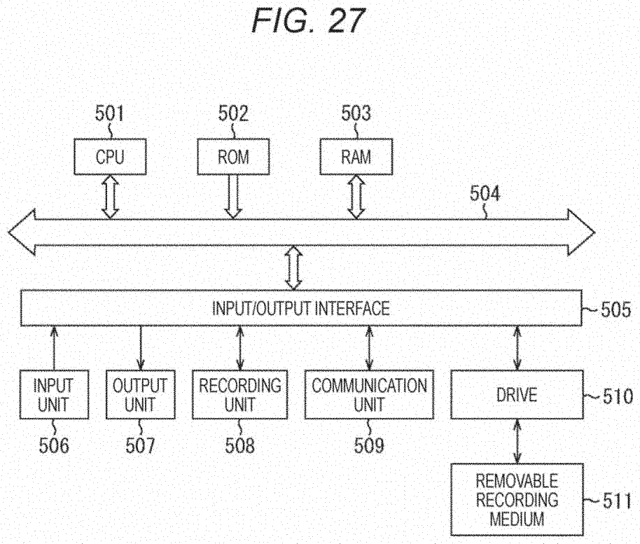

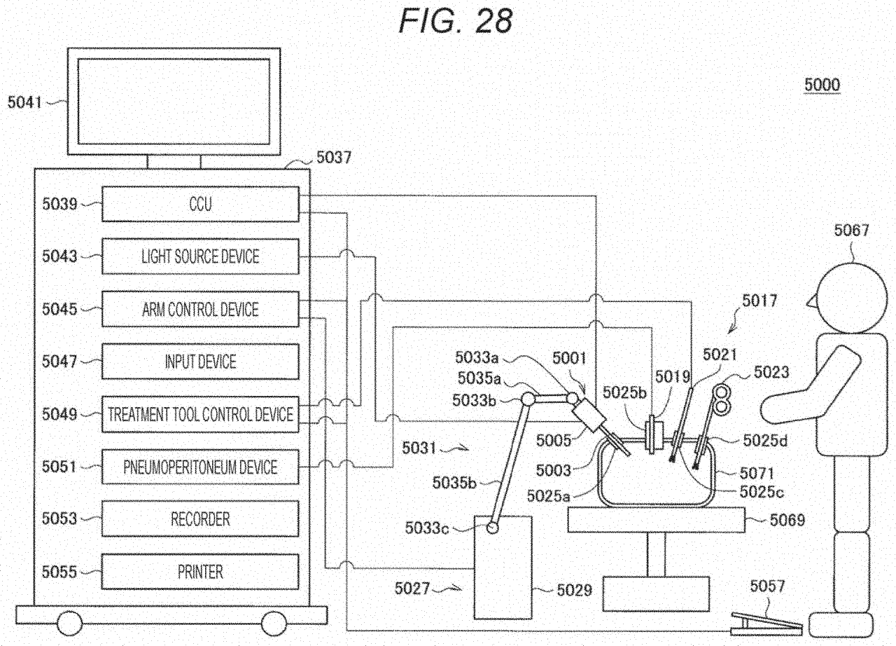

FIG. 27 is a block diagram illustrating a configuration example of hardware of a computer that executes the above-described series of processing by a program.

In the computer, a central processing unit (CPU) 501, a read only memory (ROM) 502, and a random access memory (RAM) 503 are connected to each other through a bus 504.

An input/output interface 505 is further connected to the bus 504. An input unit 506, an output unit 507, a recording unit 508, a communication unit 509, and a drive 510 are connected to the input/output interface 505.

The input unit 506 is constituted by an input switch, a button, a microphone, an imaging element, or the like. The output unit 507 is constituted by a display, a speaker, or the like. The recording unit 508 is constituted by a hard disk, a nonvolatile memory, and the like. The communication unit 509 is constituted by a network interface and the like. The drive 510 drives a removable recording medium 511 such as a magnetic disk, an optical disc, a magneto-optical disc, and a semiconductor memory.

In the computer having the above-described configuration, the CPU 501 loads a program that is recorded, for example, on the recording unit 508 into the RAM 503 through the input/output interface 505 and the bus 504, and executes the program. According to this, the above-described series of processing is performed.

The program that is executed by the computer (CPU 501) can be provided in a state of being recorded, for example, on the removable recording medium 511 as a package medium or the like. In addition, the program can be provided through a wired or wireless transmission medium such as a local area network, the Internet, and digital satellite broadcasting.

In the computer, the program can be installed in the recording unit 508 through the input/output interface 505 when the removable recording medium 511 is mounted in the drive 510. In addition, the program can be installed in the recording unit 508 after being received by the communication unit 509 through the wired or wireless transmission medium. In addition, the program can be installed in the ROM 502 or the recording unit 508 in advance.

Furthermore, the program that is executed by the computer may be a program in which processing is performed in time-series according to the procedure described in this specification, or may be a program in which processing is performed in parallel or at a necessary timing such as when a call is made.

In addition, an embodiment of the present technology is not limited to the above-described embodiment, and various modifications can be made in a range not departing from the gist of the present technology.

For example, the present technology can have a cloud computing configuration in which one function is shared by a plurality of devices and is processed in cooperation through a network.

In addition, the respective steps described in the flowcharts can be executed in a state of being distributed to a plurality of devices in addition to execution by one device.

In addition, in a case where a plurality of kinds of processing are included in one step, the plurality of kinds of processing included in one step can be executed in a state of being distributed to a plurality of devices in addition to execution by one device.

### Application Example

The technology according to the present disclosure is applicable to various products. For example, the technology according to the present disclosure may be applied to an endoscopic operating system.

FIG. 28 is a diagram illustrating an example of a schematic configuration of an endoscopic operating system 5000 to which the technology according to the present disclosure can be applied. In FIG. 28, a state in which an operator (a doctor) 5067 performs an operation on a patient 5071 on a patient bed 5069 using the endoscopic operating system 5000 is illustrated. As illustrated in the drawing, the endoscopic operating system 5000 includes an endoscope 5001, other operating tools 5017, a support arm unit 5027 that supports the endoscope 5001, and a cart 5037 on which various devices for an endoscopic operation are mounted.

In an endoscopic operation, a plurality of tubular puncturing tools, which are called trocars 5025a to 5025d, puncture an abdominal wall instead of cutting and opening the abdominal wall. Then, a lens-barrel 5003 of the endoscope 5001 or the other operating tools 5017 are inserted into a coelom of the patient 5071 from the trocars 5025a to 5025d. In the illustrated example, a pneumoperitoneum tube 5019, an energy treatment tool 5021, and a forceps 5023 are inserted into the coelom of the patient 5071 as the other operating tools 5017. In addition, the energy treatment tool 5021 is a treatment tool that is used to perform cutting and separation of a tissue, sealing of a blood vessel, or the like using a high-frequency current or ultrasonic vibration. Here, the operating tools 5017 illustrated in the drawing are merely examples and, for example, various operating tools which are generally used in an endoscopic operation such as tweezers and a retractor may be used as the operating tools 5017.

An image of an operating site in the coelom of the patient 5071 which is captured using the endoscope 5001 is displayed on a display device 5041. The operator 5067 performs treatment such as cutting an affected part, or the like, using the energy treatment tool 5021 or the forceps 5023 while seeing the image of the operating site displayed on the display device 5041 in real time. Incidentally, although not illustrated, the pneumoperitoneum tube 5019, the energy treatment tool 5021, and the forceps 5023 are supported by the operator 5067, an assistant, or the like during the operation.

(Support Arm Unit)

The support arm unit 5027 includes an arm portion 5031 that extends from a base portion 5029. In the illustrated example, the arm portion 5031 includes joints 5033a, 5033b, and 5033c and links 5035a and 5035b, and is driven under the control of an arm control device 5045. The endoscope 5001 is supported by the arm portion 5031 and the position and the posture thereof are controlled. With this arrangement, stable fixing of the position of the endoscope 5001 can be realized.

(Endoscope)

The endoscope 5001 includes the lens-barrel 5003 of which a region with a predetermined length from the tip thereof is inserted into the coelom of the patient 5071 and a camera head 5005 that is connected to the base of the lens-barrel 5003. In the illustrated example, the endoscope 5001 is illustrated as a so-called rigid endoscope including a rigid lens-barrel 5003, but the endoscope 5001 may include a so-called flexible endoscope including a flexible lens-barrel 5003.

An opening to which an objective lens is fitted is provided at the tip of the lens-barrel 5003. A light source unit 5043 is connected to the endoscope 5001, and light generated by the light source unit 5043 is guided to the tip of the lens-barrel by a light guide extending in the lens-barrel 5003 and is applied to an observation target in the coelom of the patient 5071 through the objective lens. Furthermore, the endoscope 5001 may be a direct-viewing mirror, a perspective-viewing mirror, or a side-viewing mirror.

An optical system and an imaging element are provided in the camera head 5005, and reflected light (observation light) from the observation target is condensed to the imaging element by the optical system. The observation light is photoelectrically converted by the imaging element and an electrical signal corresponding to the observation light, that is, an image signal corresponding to an observation image, is generated. The image signal is transmitted as RAW data to a camera control unit (CCU) 5039. Incidentally, a function of adjusting a magnification and a focal length by appropriately driving the optical system is mounted in the camera head 5005.

Furthermore, a plurality of imaging elements may be provided in the camera head 5005 to cope with, for example, stereoscopic vision (3D display) and the like. In this case, a plurality of relay optical systems are provided in the lens-barrel 5003 to guide observation light to the plurality of imaging elements.

(Various Devices Mounted on Cart)

The CCU 5039 is constituted by a central processing unit (CPU), a graphics processing unit (GPU), or the like and collectively controls the operations of the endoscope 5001 and the display device 5041. Specifically, with respect to an image signal received from the camera head 5005, the CCU 5039 performs various kinds of image processing for displaying an image based on the image signal, for example, development processing (demosaic processing) or the like. The CCU 5039 provides the image signal subjected to the image processing to the display device 5041. In addition, the CCU 5039 transmits a control signal to the camera head 5005 and controls driving thereof. The control signal may include information regarding imaging conditions such as a magnification or a focal length.

The display device 5041 displays an image based on the image signal subjected to the image processing by the CCU 5039 under the control of the CCU 5039. When the endoscope 5001 copes with image capturing with a high resolution such as 4K (3840 (the number of horizontal pixels)×2160 (the number of vertical pixels)), 8K (7680 (the number of horizontal pixels)×4320 (the number of vertical pixels)), or the like, and/or when the endoscope 5001 copes with 3D display, a display device that can display an image with a high resolution and/or a display device that can display a 3D image can be used as the display device 5041. When the endoscope 5001 copes with image capturing with a high resolution such as 4K or 8K, a display device with a size of 55 inches or larger can be used as the display device 5041, whereby it is possible to further obtain a sense of immersion. In addition, a plurality of display devices 5041 which are different in resolution and a size may be provided depending on usage.

For example, the light source unit 5043 is constituted by a light source such as alight emitting diode (LED), and supplies irradiation light that is used to capture an image of an operating site to the endoscope 5001.

The arm control device 5045 is constituted, for example, by a processor such as a CPU and operates in accordance with a predetermined program such that driving of the arm portion 5031 of the support arm unit 5027 is controlled in accordance with a predetermined control system.

The input device 5047 is an input interface for the endoscopic operating system 5000. A user can perform input of various pieces of information or input of an instruction to the endoscopic operating system 5000 through the input device 5047. For example, a user inputs various pieces of information regarding an operation such as body information of a patient or information regarding an operation method through the input device 5047. In addition, for example, a user inputs an instruction to drive the arm portion 5031, an instruction to change imaging conditions (such as a type of irradiation light, a magnification, and a focal length) using the endoscope 5001, an instruction to drive the energy treatment tool 5021, and the like through the input device 5047.

The type of the input device 5047 is not limited and the input device 5047 may include various known input devices. For example, a mouse, a keyboard, a touch panel, a switch, a foot switch 5057, a lever, and/or the like can be used as the input device 5047. When a touch panel is used as the input device 5047, the touch panel may be provided on a display surface of the display device 5041.

Alternatively, the input device 5047 is a device that is worn by a user such as an eyeglass wearable device, a head mounted display (HMD), or the like, and various inputs are performed on the basis of a user's gesture or visual line which is detected by the device. In addition, the input device 5047 includes a camera that can detect a user's movement, and various inputs are performed on the basis of a user's gesture or visual line detected from an image captured by the camera. Moreover, the input device 5047 includes a microphone that can collect a user's sound and various inputs are performed on the basis of sound through the microphone. In this manner, by constituting the input device 5047 such that various pieces of information is input in a noncontact manner, particularly a user (for example, the operator 5067) in a clean area can operate a device in an unclean area in a noncontact manner. In addition, since a user can operate a device without detaching a hand from a carried operating tool, it is possible to improve convenience for a user.

A treatment tool control device 5049 controls driving of the energy treatment tool 5021 for cautery or cutting of a tissue, sealing of a blood vessel, or the like. A pneumoperitoneum device 5051 supplies gas to the coelom through the pneumoperitoneum tube 5019 to expand the coelom of the patient 5071 for the purpose of securement of a visual field and securement of a work space of an operator using the endoscope 5001. A recorder 5053 is a device that can record various pieces of information regarding an operation. A printer 5055 is a device that can print various pieces of information regarding an operation in various forms such as text, image, or graph.

Characteristic configurations of the endoscopic operating system 5000 will be described below in more details.

(Support Arm Unit)

The support arm unit 5027 includes a base portion 5029 serving as a mount and an arm portion 5031 extending from the base portion 5029. In the illustrated example, the arm portion 5031 includes the plurality of joints 5033a, 5033b, and 5033c and the plurality of links 5035a and 5035b connected to the joint 5033b, but the configuration of the arm portion 5031 is simplified and illustrated in FIG. 28 for the purpose of simplification. Actually, the shapes, the numbers, and the arrangements of the joints 5033a to 5033c and the links 5035a and 5035b, the direction of rotation axes of the joints 5033a to 5033c, and the like can be appropriately set such that the arm portion 5031 has a desired degree of freedom. For example, the arm portion 5031 can suitably have six degrees of freedom or more. With this arrangement, since the endoscope 5001 can be freely moved in a movable range of the arm portion 5031, the lens-barrel 5003 of the endoscope 5001 can be inserted into the coelom of the patient 5071 in a desired direction.

Actuators are provided in the joints 5033a to 5033c, and the joints 5033a to 5033c are configured to rotate around predetermined rotation axes by driving the actuators. By controlling the driving of the actuators using the arm control device 5045, the rotation angles of the joints 5033a to 5033c are controlled and driving of the arm portion 5031 is controlled. With this arrangement, control of the position and posture of the endoscope 5001 can be realized. At this time, the arm control device 5045 can control driving of the arm portion 5031 using various known control systems such as force control or position control.

For example, by causing the operator 5067 to appropriately perform operation inputs through the input device 5047 (which includes the foot switch 5057), driving of the arm portion 5031 may be appropriately controlled by the arm control device 5045 and the position and posture of the endoscope 5001 may be controlled on the basis of the operation inputs. Through this control, the endoscope 5001 at the tip of the arm portion 5031 can be moved from an arbitrary position to an arbitrary position and can be fixedly supported at the moved position. Incidentally, the arm portion 5031 may be operated in a so-called master-slave system. In this case, the arm portion 5031 can be remotely operated by a user through the input device 5047 which is installed in a place distant from an operation room.

In addition, when force control is used, the arm control device 5045 may perform so-called power assist control for receiving an external force from a user and driving the actuators of the joints 5033a to 5033c such that the arm portion 5031 moves smoothly along the external force. With this arrangement, a user can move the arm portion 5031 with a relative small force when the user directly touches the arm portion 5031 and moves the arm portion 5031. Accordingly, it is possible to more intuitively move the endoscope 5001 with a simpler operation and to improve convenience for a user.

Here, in general, in an endoscopic operation, the endoscope 5001 is supported by a doctor who is called scopist. In contrast, since the position of the endoscope 5001 can be more reliably fixed without using a human hand by using the support arm unit 5027, it is possible to stably acquire an image of an operating site and to smoothly perform an operation.

Incidentally, the arm control device 5045 may not be necessarily provided in the cart 5037. In addition, the arm control device 5045 may not be necessarily constituted by a single device. For example, the arm control device 5045 may be provided in each of the joints 5033a to 5033c of the arm portion 5031 of the support arm unit 5027, or driving control of the arm portion 5031 may be realized in cooperation of a plurality of arm control devices 5045.

(Light Source Unit)

The light source unit 5043 supplies irradiation light when capturing an image of an operating site to the endoscope 5001. The light source unit 5043 is constituted, for example, by an LED, a laser beam source, or a white light source which is constituted by a combination thereof. At this time, when a white light source is constituted in combination of RGB laser beam sources, output intensity and an output time of each color (each wavelength) can be controlled with high accuracy and thus white balance adjustment of a captured image in the light source unit 5043 can be performed. In addition, in this case, by irradiating an observation target with laser beams from the RGB laser light sources in a time division manner and controlling driving of the imaging element of the camera head 5005 in synchronization with the irradiation time, images corresponding to RGB colors can also be captured in a time division manner. According to this method, it is possible to obtain a color image without providing a color filter in the imaging element.

In addition, driving of the light source unit 5043 may be controlled such that the intensity of output light thereof changes every predetermined time. By controlling driving of the imaging element of the camera head 5005 in synchronization with the change time of the light intensity such that images are acquired in a time division manner and combining the acquired images, it is possible to generate an image with a high dynamic range without black defects and halation.

In addition, the light source unit 5043 may be configured to supply light of a predetermined wavelength band corresponding to special light observation. In the special light observation, so-called narrow-band optical observation (narrow band imaging) of capturing an image of a predetermined tissue such as a blood vessel of a mucous membrane surface layer is performed, for example, by applying light of a narrower band than that of irradiation light (that is, white light) at the time of normal observation using wavelength dependency of light absorption in a body tissue. Alternatively, in the special light observation, fluorescent observation of acquiring an image using fluorescent light generated by irradiation with excitation light may be performed. In the fluorescent observation, irradiating a body tissue with excitation light and observing fluorescent light from the body tissue (auto-fluorescence observation), or locally injecting a reagent such as indocyanine green (ICG) into a body tissue and irradiating the body tissue with excitation light corresponding to a fluorescence wavelength of the reagent to acquire a fluorescent image, or the like can be performed. The light source unit 5043 can be configured to supply narrow-band light and/or excitation light corresponding to the special light observation.

(Camera Head and CCU)

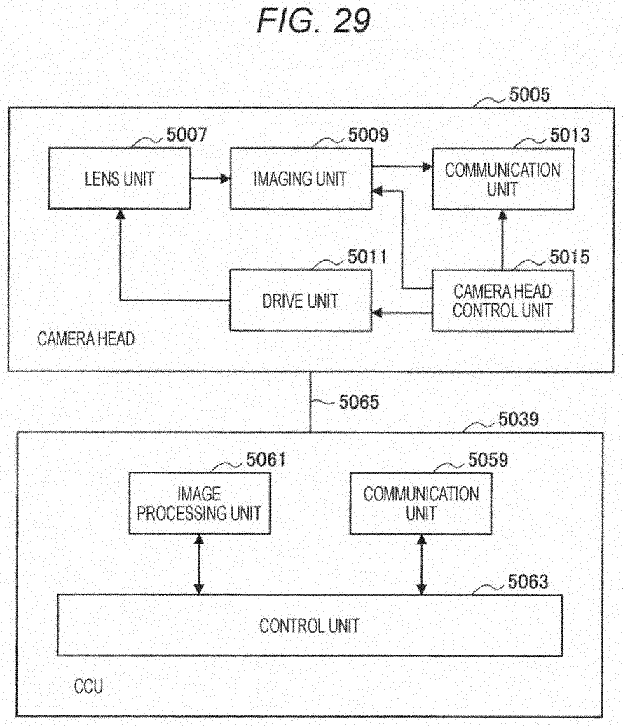

The functions of the camera head 5005 and the CCU 5039 of the endoscope 5001 will be described below in more details with reference to FIG. 29. FIG. 29 is a block diagram illustrating an example of the functional configuration of the camera head 5005 and the CCU 5039 illustrated in FIG. 28.

Referring to FIG. 29, the camera head 5005 includes a lens unit 5007, an imaging unit 5009, a drive unit 5011, a communication unit 5013, and a camera head control unit 5015 as functional units thereof. In addition, the CCU 5039 includes a communication unit 5059, an image processing unit 5061, and a control unit 5063 as functional units thereof. The camera head 5005 and the CCU 5039 are connected to each other to perform bidirectional communication therebetween through a transmission cable 5065.

First, the functional configuration of the camera head 5005 will be described. The lens unit 5007 is an optical system that is provided in a connection portion to the lens-barrel 5003. Observation light supplied from the tip of the lens-barrel 5003 is guided to the camera head 5005 and is incident on the lens unit 5007. The lens unit 5007 is constituted by combination of a plurality of lenses including a zoom lens and a focus lens. Optical characteristics of the lens unit 5007 are adjusted such that observation light is condensed to a light receiving surface of an imaging element of the imaging unit 5009. In addition, the zoom lens and the focus lens are constituted such that the positions on the optical axis thereof are movable to adjust the magnification and the focal point of a captured image.

The imaging unit 5009 is constituted by an imaging element and is disposed in the rear stage of the lens unit 5007. Observation light passing through the lens unit 5007 is condensed to the light receiving surface of the imaging element and an image signal corresponding to an observation image is generated by photoelectric conversion. The image signal generated by the imaging unit 5009 is supplied to the communication unit 5013.

For example, a complementary metal oxide semiconductor (CMOS) type image sensor with a Bayer array that can capture a color image is used as the imaging element constituting the imaging unit 5009. Furthermore, for example, an imaging element that can cope with image capturing with a high resolution of 4K or higher may be used as the imaging element. When an image of an operating site with a high resolution is acquired, the operator 5067 can understand the state of the operating site in more details and can more smoothly perform an operation.

In addition, the imaging element constituting the imaging unit 5009 has a pair of imaging elements for acquiring each of right-eye and left-eye image signals corresponding to 3D display. By performing 3D display, the operator 5067 can more accurately understand a depth of a biological tissue in an operating site. Incidentally, when the imaging unit 5009 is constituted in a multi-plate system, a plurality of lens units 5007 may be provided to correspond to the imaging elements.

In addition, the imaging unit 5009 may not be necessarily provided in the camera head 5005. For example, the imaging unit 5009 may be provided in the lens-barrel 5003 immediately after the objective lens.

The drive unit 5011 is constituted by an actuator and moves the zoom lens and the focus lens of the lens unit 5007 by a predetermined distance along an optical axis under the control of the camera head control unit 5015. With this arrangement, the magnification and the focal point of a captured image which is captured by the imaging unit 5009 can be appropriately adjusted.

The communication unit 5013 is constituted by a communication device that transmits and receives various pieces of information to and from the CCU 5039. The communication unit 5013 transmits an image signal acquired from the imaging unit 5009 as RAW data to the CCU 5039 through the transmission cable 5065. At this time, it is preferable that the image signal is transmitted by optical communication to display a captured image of an operating site with low latency. This is because since an operator 5067 performs an operation while observing a state of an affected part using a captured image at the time of the operation, it is necessary to display a moving image of an operating site in real time for the purpose of a more safe and reliable operation. When optical communication is used, a photoelectric conversion module that converts an electrical signal into an optical signal is provided in the communication unit 5013. The image signal is converted into an optical signal by the photoelectric conversion module and then is transmitted to the CCU 5039 through the transmission cable 5065.

In addition, the communication unit 5013 receives a control signal for controlling driving of the camera head 5005 from the CCU 5039. The control signal includes, for example, information regarding imaging conditions such as information for designating a frame rate of a captured image, information for designating an exposure value at the time of imaging, and/or information for designating the magnification and the focal point of a captured image. The communication unit 5013 supplies the received control signal to the camera head control unit 5015. Incidentally, the control signal from the CCU 5039 may also be transmitted by optical communication. In this case, a photoelectric conversion module that converts an optical signal into an electrical signal is provided in the communication unit 5013. The control signal is converted into an electrical signal by the photoelectric conversion module and then is supplied to the camera head control unit 5015.

Incidentally, imaging conditions such as the frame rate, the exposure value, the magnification, and the focal point are automatically set by the control unit 5063 of the CCU 5039 on the basis of the acquired image signal. That is, so-called auto exposure (AE), auto focus (AF), and auto white balance (AWB) functions are mounted in the endoscope 5001.

The camera head control unit 5015 controls driving of the camera head 5005 on the basis of a control signal received from the CCU 5039 through the communication unit 5013. For example, the camera head control unit 5015 controls driving of the imaging element of the imaging unit 5009 on the basis of information for designating the frame rate of a captured image and/or information for designating exposure at the time of imaging. In addition, for example, the camera head control unit 5015 appropriately moves the zoom lens and the focus lens of the lens unit 5007 through the drive unit 5011 on the basis of information for designating the magnification and the focal point of a captured image. The camera head control unit 5015 may further have a function of storing information for identifying the lens-barrel 5003 or the camera head 5005.

Furthermore, when the configuration of the lens unit 5007, the imaging unit 5009, or the like is disposed in a sealed structure with high airtightness and waterproofness, the camera head 5005 can have resistance to autoclave sterilization.

Next, a functional configuration of the CCU 5039 will be described. The communication unit 5059 is constituted by a communication device that transmits and receives various pieces of information to and from the camera head 5005. The communication unit 5059 receives an image signal transmitted from the camera head 5005 through the transmission cable 5065. At this time, the image signal can be appropriately transmitted by optical communication as described above. In this case, a photoelectric conversion module that converts an optical signal into an electrical signal is provided in the communication unit 5059 to correspond to the optical communication. The communication unit 5059 supplies an electrical signal into which the image signal has been converted to the image processing unit 5061.

In addition, the communication unit 5059 transmits a control signal for controlling driving of the camera head 5005 to the camera head 5005. The control signal may also be transmitted by optical communication.

The image processing unit 5061 performs various image processing on an image signal which is RAW data transmitted from the camera head 5005. Examples of the image processing include various known signal processing such as development processing, image quality enhancing processing (such as band emphasizing processing, super-resolution processing, noise reduction (NR) processing, and/or camera shake correcting processing), and/or enlargement processing (an electronic zoom process). In addition, the image processing unit 5061 performs detection processing for an image signal for performing the AE function, the AF function, and the AWB function.

The image processing unit 5061 is constituted by a processor such as a CPU or a GPU, and the above-described image processing or the detection processing can be performed by allowing the processor to operate in accordance with a predetermined program. Incidentally, when the image processing unit 5061 is constituted by a plurality of GPUs, the image processing unit 5061 appropriately divides information associated with an image signal and performs image processing in parallel by the plurality of GPUs.

The control unit 5063 performs various controls for imaging an operating site using the endoscope 5001 and display of the captured image. For example, the control unit 5063 generates a control signal for controlling driving of the camera head 5005. At this time, when imaging conditions are input by a user, the control unit 5063 generates a control signal on the basis of the input by the user. Alternatively, when the AE function, the AF function, and the AWB function are mounted in the endoscope 5001, the control unit 5063 appropriately calculates an optimal exposure value, an optimal focal length, and a white balance on the basis of the result of the detection processing in the image processing unit 5061, and generates a control signal.

In addition, the control unit 5063 displays an image of an operating site on the display device 5041 on the basis of an image signal subjected to image processing by the image processing unit 5061. At this time, the control unit 5063 recognizes various objects in the image of the operating site using various image recognition technologies. For example, the control unit 5063 can recognize an operating tool such as a forceps, a specific biological part, bleeding, mist at the time of use of the energy treatment tool 5021, or the like by detecting the shape, color, or the like of an edge of an object included in the image of the operating site. The control unit 5063 displays various pieces of operation assisting information to overlap the image of the operating site using the recognition result at the time of displaying the image of the operating site on the display device 5041. When the operation assisting information is displayed to overlap and is presented to the operator 5067, it is possible to more safe and reliably perform an operation.

The transmission cable 5065 that connects the camera head 5005 and the CCU 5039 to each other is an electrical signal cable corresponding to communication of an electrical signal, an optical fiber corresponding to optical communication, or a combined cable thereof.

Here, in the illustrated example, communication is performed in a wired manner using the transmission cable 5065, but communication between the camera head 5005 and the CCU 5039 may be performed in a wireless manner. When communication therebetween is performed in a wireless manner, the transmission cable 5065 does not need to be installed in an operation room and thus it is possible to solve a problem that movement of a medical staff in the operation room is hindered by the transmission cable 5065.

An example of the endoscopic operating system 5000 to which the technology according to the present disclosure can be applied has been described above. Incidentally, the endoscopic operating system. 5000 has been described herein as an example, but a system to which the technology according to the present disclosure can be applied is not limited to the example. For example, the technology according to the present disclosure may be applied to an examination flexible endoscope system or a microscope operating system.

The technology according to the present disclosure can be suitably applied to the display device 5041 among the above-described configurations. It may be more suitable for an operator that an image which is displayed on the display device 5041 is displayed in a vertically or laterally inverted state using the flip function depending on the position at which the operator 5067 stands, the arrangement of the display device 5041, the direction of the endoscope 5001, or the like.

When the technology according to the present disclosure is applied to the case, in a case where the flip function is ON, control is performed so that an operation related to a direction that is instructed with the display device 5041 set as a reference can be performed in correspondence with an inverted direction when the direction instruction input is input from the input device 5047. According to this, it is possible to perform an operation without worrying about ON and OFF of flip setting, and thus it is possible to improve convenience of the endoscopic operating system 5000.

In addition, the present technology can employ the following configurations.

(1) An image processing device including:
a setting unit that sets a flip function of displaying an image in a state of being vertically inverted to ON or OFF; and
a control unit that performs control so that a display screen is allowed to be displayed on the basis of setting of the flip function, and in a case of receiving an operation instruction related to a predetermined direction from an external device, an operation related to the predetermined direction is performed with the display screen set as a reference.
   (2) The image processing device according to (1),
in which in a case where the flip function is set to ON, the control unit allows the display screen to be displayed in a state of being vertically inverted.
   (3) The image processing device according to (2),
in which in a case where the flip function is set to ON, when receiving an operation instruction related to an upward direction with the external device set as a reference from the external device, the control unit performs control so that an operation to the upward direction with the vertically and invertedly displayed display screen set as a reference is performed.
   (4) The image processing device according to (2) or (3),
in which in a case where the flip function is set to OFF, the control unit allows the display screen to be displayed without being vertically inverted, and performs control so that, when receiving an operation instruction related to an upward direction with the external device set as a reference from the external device, an operation to the upward direction with the display screen displayed without vertical inversion set as a reference is performed.
   (5) The image processing device according to any one of (1) to (4),
in which the display screen is a menu screen in which a plurality of menu items are arranged in parallel.
   (6) The image processing device according to (5),
in which in a case where the flip function is set to ON, the control unit allows the menu screen to be displayed in a state of being vertically inverted, and when receiving an operation instruction related to the predetermined direction from the external device, the control unit selects the menu item on the menu screen with the vertically and invertedly displayed menu screen set as a reference on the basis of the operation instruction related to the predetermined direction.
   (7) The image processing device according to any one of (1) to (6),
in which in a case of receiving an operation instruction associated with no direction from the external device, the control unit performs control so that the operation associated with no direction is performed without depending on setting of the flip function.
   (8) The image processing device according to any one of (1) to (7),
in which in a case where the flip function is set to ON, at least one of vertical inversion of an image acquired through image capturing, exchange of right and left channels of collected sound acquired through sound collection, vertical inversion display of the display screen, or change of allocation functions between operation units associated with directions different from each other is performed.
   (9) A control method including steps of:
setting a flip function of displaying an image in a state of being vertically inverted to ON or OFF; and
performing control so that a display screen is allowed to be displayed on the basis of setting of the flip function, and in a case of receiving an operation instruction related to a predetermined direction from an external device, an operation related to the predetermined direction is performed with the display screen set as a reference.
   (10) A program that allows a computer to execute processing including steps of:
setting a flip function of displaying an image in a state of being vertically inverted to ON or OFF; and
performing control so that a display screen is allowed to be displayed on the basis of setting of the flip function, and in a case of receiving an operation instruction related to a predetermined direction from an external device, an operation related to the predetermined direction is performed with the display screen set as a reference.

### REFERENCE SIGNS LIST

11 Imaging device
22 Sound collection unit
61 Display unit
63 Upward button
64 Downward button
65 Leftward button
66 Rightward button
131 Imaging unit
133 Control unit
135 Communication unit
136 Input/output terminal
151 Setting unit
152 OSD image generation unit
153 Display control unit
154 Recording control unit

1. An image processing device comprising:
a setting unit that sets a flip function of displaying an image in a state of being vertically inverted to ON or OFF; and
a control unit that performs control so that a display screen is allowed to be displayed on a basis of setting of the flip function, and in a case of receiving an operation instruction related to a predetermined direction from an external device, an operation related to the predetermined direction is performed with the display screen set as a reference.

2. The image processing device according to claim 1,
wherein in a case where the flip function is set to ON, the control unit allows the display screen to be displayed in a state of being vertically inverted.

3. The image processing device according to claim 2,
wherein in a case where the flip function is set to ON, when receiving an operation instruction related to an upward direction with the external device set as a reference from the external device, the control unit performs control so that an operation to the upward direction with the vertically and invertedly displayed display screen set as a reference is performed.

4. The image processing device according to claim 2,
wherein in a case where the flip function is set to OFF, the control unit allows the display screen to be displayed without being vertically inverted, and performs control so that, when receiving an operation instruction related to an upward direction with the external device set as a reference from the external device, an operation to the upward direction with the display screen displayed without vertical inversion set as a reference is performed.

5. The image processing device according to claim 1,
wherein the display screen is a menu screen in which a plurality of menu items are arranged in parallel.

6. The image processing device according to claim 5,
wherein in a case where the flip function is set to ON, the control unit allows the menu screen to be displayed in a state of being vertically inverted, and when receiving an operation instruction related to the predetermined direction from the external device, the control unit selects the menu item on the menu screen with the vertically and invertedly displayed menu screen set as a reference on a basis of the operation instruction related to the predetermined direction.

7. The image processing device according to claim 1,
wherein in a case of receiving an operation instruction associated with no direction from the external device, the control unit performs control so that the operation associated with no direction is performed without depending on setting of the flip function.

8. The image processing device according to claim 1,
wherein in a case where the flip function is set to ON, at least one of vertical inversion of an image acquired through image capturing, exchange of right and left channels of collected sound acquired through sound collection, vertical inversion display of the display screen, or change of allocation functions between operation units associated with directions different from each other is performed.

9. A control method comprising steps of:
setting a flip function of displaying an image in a state of being vertically inverted to ON or OFF; and
performing control so that a display screen is allowed to be displayed on a basis of setting of the flip function, and in a case of receiving an operation instruction related to a predetermined direction from an external device, an operation related to the predetermined direction is performed with the display screen set as a reference.

10. A program that allows a computer to execute processing including steps of:
setting a flip function of displaying an image in a state of being vertically inverted to ON or OFF; and
performing control so that a display screen is allowed to be displayed on a basis of setting of the flip function, and in a case of receiving an operation instruction related to a predetermined direction from an external device, an operation related to the predetermined direction is performed with the display screen set as a reference.
